(19) United States
(12) Patent Application Publication
(10) Pub. No.: US 2026/0289602 A1
(43) Pub. Date: Sep. 24, 2026

(54) SYSTEMS AND METHODS FOR MANAGING REAL ESTATE

(71) Applicant: Stake Network, Inc., Seattle, WA (US)

(72) Inventors: Rowland Hobbs, New York, NY (US); James Jacobson, New York, NY (US)

(21) Appl. No.: 19/684,753

(22) Filed: May 21, 2026

Related U.S. Application Data
(63) Continuation of application No. 18/767,230, filed on Jul. 9, 2024, now abandoned.
Application No. 18/767,230 is a continuation-in-part of application No. PCT/US2023/086586, filed on Dec. 31, 2023.
Application No. PCT/US2023/086586 is a continuation-in-part of application No. 18/149,084, filed on Dec. 31, 2022, now abandoned.
Application No. 18/767,230 is a continuation-in-part of application No. 18/149,084, filed on Dec. 31, 2022, now abandoned.
Application No. 18/149,084 is a continuation of application No. PCT/US22/79076, filed on Nov. 1, 2022.
Application No. 18/149,084 is a continuation-in-part of application No. 16/581,107, filed on Sep. 24, 2019, now abandoned.
(60) Provisional application No. 62/735,695, filed on Sep. 24, 2018.
(60) Provisional application No. 62/736,599, filed on Sep. 26, 2018.
(60) Provisional application No. 63/274,187, filed on Nov. 1, 2021.
(60) Provisional application No. 63/478,113, filed on Dec. 30, 2022.

(51) Int. Cl. G06Q 30/0226; G06K 19/06; G06Q 10/0631; G06Q 30/0207; G06Q 30/0645; G06Q 50/163

(52) U.S. Cl. CPC G06Q 30/0226; G06K 19/06037; G06Q 10/06311; G06Q 30/0207; G06Q 30/0645; G06Q 50/163

(57) ABSTRACT

Systems and methods for generating dynamic reward workflows based on determined tenant behaviors are described and contemplated herein. The method comprises providing a resident interface configured to receive tenant data. The method further comprises determining a tenant behavior based on the tenant data and generating a reward workflow based on the tenant behavior. A reward can be provided based on a determination that a task associated with the workflow is complete. By incorporating insights based on tenant and property data into reward workflows, embodiments address the need for predictive and customized reward workflows that maximize resource allocation for tenant retention.

### CROSS-REFERENCE TO RELATED APPLICATIONS

The present patent application claims the benefit of priority to and is a continuation of U.S. patent application Ser. No. 18/767,230, filed Jul. 9, 2024, which in turn is a continuation-in-part of International Patent Application No. PCT/US2023/86586, filed Dec. 31, 2023, which in turn claims the benefit of priority to and is a continuation-in-part of U.S. patent application Ser. No. 18/149,084, filed Dec. 31, 2022, and U.S. Provisional Patent Application Ser. No. 63/478,113, filed Dec. 30, 2022.

The present patent application claims the benefit of priority to and is a continuation of U.S. patent application Ser. No. 18/767,230, filed Jul. 9, 2024, which in turn is a continuation-in-part of U.S. patent application Ser. No. 18/149,084, filed Dec. 31, 2022, which in turn is related to and is a continuation of PCT/US2022/79076, filed Nov. 1, 2022, which in turn claims the benefit of priority to U.S. Provisional Patent Application No. 63/274,187, filed Nov. 1, 2021.

The present patent application claims the benefit of priority to and is a continuation of U.S. patent application Ser. No. 18/767,230, filed Jul. 9, 2024, which in turn is a continuation-in-part of U.S. patent application Ser. No. 18/149,084, filed Dec. 31, 2022, which in turn is related to and is a continuation-in-part of U.S. patent application Ser. No. 16/581,107, filed Sep. 24, 2019, which in turn claims the benefit of priority to U.S. Provisional Patent Application Ser. No. 62/735,695 filed Sep. 24, 2018 and U.S. Provisional Patent Application Ser. No. 62/736,599 filed Sep. 26, 2018. Each of the foregoing patent applications is incorporated by reference in its entirety for any purpose whatsoever.

### TECHNICAL FIELD

Embodiments relate to the field of property management. More particularly, embodiments facilitate the creation, provisioning, and execution of custom reward workflows for renters and management schemas for owners within a dynamic property management platform.

### BACKGROUND

In the ever-evolving field of property management, ensuring tenet retention and satisfaction remains a paramount challenge. Traditional solutions often require manual data entry, which can be inflexible in adapting to market demands and regulatory requirements. Additionally, many traditional property management solutions lack integration capabilities, or otherwise fail to provide accessible and scalable management of tenet data, resulting in a negative tenant experience and limited analytical capabilities. Property owners and managers do not typically have sufficient information on renter behavior, let alone mechanisms for organizing renter-specific data.

As a result, owners of housing units spend significant resources trying to acquire renters, and renters move more often. Similarly, tenants often lose money by renting through a variety of mechanisms. For example, rental deposits can tie-up free cash each time the tenant moves to a new residence, and climbing rental prices may leave tenants with monthly rental expenses. Accordingly, tenants are often unable to work towards long-term financial goals.

Therefore, there is a need for systems and methods that streamline property management and tenet relations, improve data security and accuracy, and provide better visibility into property performance.

### SUMMARY

Embodiments described or otherwise contemplated herein substantially meet the aforementioned needs of the industry. Embodiments described herein include systems and methods for generating dynamic reward workflows based on determined tenant behaviors. By incorporating insights based on tenant and property data into reward workflows, embodiments address the need for predictive and customized reward workflows that maximize resource allocation for tenant retention.

In a feature and advantage of embodiments, interpreting associations between mapped tenant data and property data, allows for generation of reward workflows that enhance tenant retention.

In a feature and advantage of embodiments, incorporation of dynamic recommendations into reward workflow generation and can improve efficiency over time. For example, output data evidencing the impact of reward workflows can be consider to refine development of future reward workflows and/or update tenant behavior analysis.

The purpose and advantages of the present disclosure will be set forth in and become apparent from the description that follows. Additional advantages of the disclosed embodiments will be realized and attained by the methods and systems particularly pointed out in the written description hereof, as well as from the appended drawings and patent applications incorporated by reference herein.

In some embodiments, a system for managing properties and tenants includes a property management platform. The property management platform can (e.g., is configured to) perform one or more of the following, according to embodiments. The property management platform can implement an interface engine configured to provide a resident interface. The resident interface is configured to receive tenant data and task completion data. The property management platform can implement a reward engine (e.g., which may be referred to as an offer engine or offer manager) configured to generate a reward workflow based on the tenant data. The reward workflow is associated with (e.g., includes) a task and a reward. The property management platform can implement a property engine. The property engine is configured to receive, via the resident interface, task completion data associated with the reward workflow, determine that the task is complete based on a comparison of the task completion data to the task, and send, based on the determination that the task is complete, the reward via the resident interface.

In some embodiments, the interface engine is configured to send, via the resident interface, instructions for performing the task. In some implementations, the task can be, for example, one or more of to save an amount of money or to make an on-time rent payment, and wherein the reward is a cash reward. In some implementations, the task can be, for example, one or more of referring a prospective tenant, signing a new lease, renewing a lease, providing proof of renter insurance, paying rent on time, taking a tour of a residence, submitting an application for renting a residence, or connecting a financial institution account to the property management platform.

In some embodiments, the task completion data includes a photograph evidencing completion of the task, a timestamp associated with a time the photograph was taken, and geocoordinates associated with a location the photograph was taken. In some implementations, the property engine is configured to determine that the task is complete based on at least one of the timestamp or the geocoordinates. In some implementations, the task completion data includes data obtained from a QR code at a location associated with the task.

In some embodiments, the interface engine is configured to provide a property management interface to receive property data and/or user input from a property manager. The property management interface can receive property data indicating an attribute of a property. The reward engine can be configured to generate the reward workflow based on the property data. In some implementations, the determination that the task is complete is based on a comparison of the task completion data to the property data. In some implementations, the property data includes as least one of rent for a residence, cost of a residence, occupancy rate of a residence, delinquency rate of a residence, or end date of a lease.

In some embodiments, the property management platform is configured to implement an artificial intelligence (AI) engine. The AI engine (e.g., which may be referred to as an insight engine) is configured to determine a renter behavior based on the tenant data. In some implementations, the reward engine is configured to generate the reward workflow based on the renter behavior. In some implementations, one or more of a magnitude of the reward, a type of the reward, or a time the reward workflow including the reward is sent is based on the renter behavior.

In some embodiments, the AI engine is configured to generate, based on the renter behavior, a recommendation identifying an action to perform. In some implementations, the recommendation is associated with improving tenant retention and is sent by a property management interface provided by the interface engine. The recommendation can be to provide a cash reward to a tenant. In some implementations, the reward engine is configured to receive, via the property management interface, an indication that the reward workflow is approved.

In some implementations, the recommendation is associated with a tenant goal and is sent by the resident interface. In such implementations, the tenant data can include an indication that a tenant did not pay rent on time. The action associated with the recommendation and the tenant goal can be associated with incentivizing timely payment of rent in the future.

In some embodiments, the tenant data includes financial data extracted from digitized financial transaction information. For example, the financial data can includes at least one of vendor information identifying a vendor of a purchase made by a tenant or stock keeping unit (SKU) information that identifies an item associated with the purchase.

In some embodiments, the AI engine is configured to determine a purchasing pattern of a renter based on the financial data. In some implementations, the reward engine is configured to generate the reward workflow based on the purchasing pattern.

In some embodiments, the property management platform can be communicatively coupled to a components database configured to store reward workflow components. In some implementations, the reward engine is configured to generate the reward workflow based on one or more of the reward workflow components stored in the components database.

In some embodiments, a method for managing properties and tenants comprises: providing a resident interface configured to receive tenant data and task completion data; receiving, via the resident interface, tenant data; determining a tenant behavior based on the tenant data; generating a reward workflow based on the tenant behavior, wherein the reward workflow is associated with a task and a reward; receiving, via the resident interface, task completion data associated with the reward workflow; determining that the task is complete based on a comparison of the task completion data to the task; and sending, based on the determination that the task is complete, the reward via the resident interface.

In some embodiments, a non-transitory computer readable medium comprises instructions that, when executed by a processor, cause the processor to implement: an interface engine configured to: provide a resident interface configured to receive tenant data and task completion data, and receive, via the resident interface, tenant data; a reward engine configured to generate a reward workflow based on the tenant data, wherein the reward workflow is associated with a task and a reward; and a property engine configured to: receive, via the resident interface, task completion data associated with the reward workflow, determine that the task is complete based on a comparison of the task completion data to the task, and send, based on the determination that the task is complete, the reward via the resident interface.

In some embodiments, a system for property management comprises an insight engine, an offer engine, and an interface engine. The insight engine can determine renter behavior based on tenant data. The insight engine can derive, from the renter behavior, an insight associated with a property metric. The insight can be presented, for example to an administrative user such as a property manager, through a property management interface (e.g., loyalty cloud) provisioned by the interface engine. The offer engine can determine a cash back reward based on the insight and/or renter behavior. The cash back reward can be associated with an action to improve the property metric. For example, the cash back reward can be a 3% cash back for an on-time rent payment to improve a percentage of timely rent payments of a property. The value of the cash back reward can be determined based on the renter behavior and/or other tenant data. The cash back reward can be presented via an interface of an application provided by the interface engine.

It is to be understood that both the foregoing general description and the following detailed description are exemplary and are intended to provide further explanation of the embodiments disclosed herein.

The accompanying drawings, which are incorporated in and constitute part of this specification, are included to illustrate and provide a further understanding of the method and system of the disclosure. Together with the description, the drawings serve to explain the principles of the disclosed embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for managing properties and tenants, according to an embodiment.

FIGS. 2-8 are examples of resident interfaces illustrating aspects of a property management platform, according to an embodiment.

FIG. 9 is a block diagram of a system for managing properties and tenants, according to an embodiment.

FIGS. 10A-C are process flow diagrams of a method for managing finances through a property management platform, according to an embodiment.

FIG. 11 is a flowchart of a method for generating a reward workflow based on tenant data, according to an embodiment.

FIG. 12 is a flowchart of a method for generating a recommendation based on determined tenant behavior, according to an embodiment.

FIG. 13 is a flowchart of a method for providing a cash reward based on renter behavior insights, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Systems and methods for creation, provisioning, and execution of custom reward workflows for renters and management schemas for owners within a dynamic property management platform are described and contemplated herein. The dynamic property management platform can be a cloud-based engine configured to manage workflow components and concessions.

Tenant turnover can significantly increase overall costs of real estate management for all involved parties. For example, when a tenant moves out a period of vacancy can occur before a new tenant moves in. During this time, the property generates no rental income, resulting in vacancy losses. The longer the property remains vacant, the greater the financial impact on the property owner or manager, which is then imputed to the future tenant through increased rent. Most new leases are not profitable until the last month. Therefore, even one month of an empty unit (e.g., a housing unit or other type of real-estate unit) can make the difference of being profitable.

Moreover, property owners often incur expenses related to marketing and advertising to attract new tenants, such as listing fees on rental websites, signage, and promotional materials. These costs can accumulate, particularly in competitive rental markets. Offers such as “free month of rent” reward renters for moving. Accordingly, reducing tenant turnover through retention strategies, such as providing excellent customer service, incentives and concessions for loyalty, and implementing transparent processes, can help mitigate these costs and improve overall profitability in real estate management.

The embodiments described herein provide feature(s) associated with managing property performance across a real estate portfolio and managing rental concessions, discounts, marketing offers, and pricing. In one aspect embodiments provide for improved management and allocation of rewards focused on retaining and managing renters. For example, embodiments allow for a dynamic property management platform that supports custom reward workflows, such as loyalty programs, rewards programs, cash-back, and/or overall tenant management and retention programs.

Reward workflows can be user-defined or automatically generated and present configurable processes, for example, to automate ad hoc user concessions. Reward workflows generally comprise the following workflow components: an input (e.g., tenant action), an output (e.g., concession), and a condition (e.g., transform rules). As will be described, each of the aforementioned components can comprise multiple respective components, such as at least two inputs, at least two outputs, or at least two conditions.

Reward workflows can comprise one or more inputs, which are actions that can lead to the grant of an output. An input can initialize execution of an entire reward workflow or a subset of operations within a reward workflow. For example, an input can serve as a transition between stages of a reward workflow (e.g., tiers of a reward program). For example, an input can serve to resume a reward workflow after a stopping condition (e.g., failure to pay rent) is detected/determined.

In one aspect, the inputs can include tenant data and/or property data indicative of an action taken (or not taken, for example in the case of failure to pay rent) by a tenant. For example, the action can be requested by the platform as part of a larger reward workflow. In such an example, a platform can determine whether a condition of the reward workflow is satisfied based on input (e.g., the tenant data and/or property data). If the condition is satisfied, the platform executes a transaction to provide an output (e.g., financial reward) to the renter for taking the action.

Actions taken by a tenant that can be considered input for the purposes of a reward workflow include, for example, one or more of: (i) referring a prospective tenant to a landlord; (ii) signing a new lease; (iii) renewing a lease; (iv) providing proof of renter insurance; (v) paying rent on time; (vi) improving their credit score; (vii) taking a tour of a residence; (viii) submitting an application for renting a residence; (ix) achieving a predetermined savings target; (x) responding to a rental listing; (xi) engaging in a rental showing; (xii) for connecting a financial institution account to a user account of the renter; (xiii) for engaging in a community activity; (xiv) for reducing utility usage; (xv) maintaining renter insurance for a predetermined period of time; (xvi) activating a debit card through an issuer; or (xvii) activating a checking account through an issuer.

Reward workflows can comprise one or more outputs, which are automatic operations to be executed by a platform, for example, in response to a satisfied condition. Example outputs, for example, include one or more of: providing a financial reward (e.g., a cash reward, a gift card), a deal (e.g., voucher, discount on rent or services), or other concession (e.g., perks and amenities); changing permissions of a user; providing a recommendation, or sending a communication (e.g., an email, report, etc.).

In some embodiments, inputs and/or outputs can be predefined (e.g., known by a platform) or customized. A platform can provide a library of actions that can be used as inputs and/or outputs. To facilitate an inclusion of custom workflow components (e.g., based on specific property characteristics), users (e.g., property managers) can be provided with development tools, such as APIs, to integrate external data sources. In examples, a graphical user interface (GUI) can be provided to users to receive input in generating reward workflows. For example, a property manager can define, using the GUI, that a particular reward should be a tenant gaining access to a property's pool via a key card belonging to the tenant. In such an example, property attributes, such as the presence of the pool as an amenity and the use of a key card system, can be specified by the property manager. The GUI can incorporate user-friendly operations and recommendations to facilitate reward workflow customization, in some cases without coding (e.g., using drag and drop functionality).

Workflows can comprise one or more condition(s). A condition is a logical expression that defines the next operation of workflow execution. In examples, conditions can be based on attributes that must be present for a transaction to be executed within a workflow. For example, a condition can specify that a tenant must sign a lease extension before a reward action is taken. Conditions can include escalations, such as procedures for escalating rewards or tasks to higher levels of authority or responsibility (e.g., for approval).

In some implementations, the (i) timing, (ii) magnitude, and/or (iii) type of output (e.g., financial reward) can be selected or adjusted based on a platform determining the extent to which a condition is satisfied. For example, a condition can be binary such that the condition is either satisfied or not satisfied. For example, a condition can be non-binary, such that the condition can be satisfied to a degree (e.g., 0.1, 0.65) based on input data. Satisfaction of a condition is determined by analysis of inputs (e.g., tenant data, such as renter behaviors) and associated attributes.

In some embodiments, conditions can be time-based. For example, associations between inputs and outputs can be based on a time of year or month. For example, associations between inputs and outputs can be based on tenant-specific time characteristics (e.g., impending expiration of a lease).

In examples, workflows can comprise feedback loops or mechanisms for collecting and incorporating reward data to improve the efficiency or efficacy of a reward workflow. For example, performance of a reward workflow can be evaluated and adjusted by monitoring data, such as a retention rate of tenants given certain rewards.

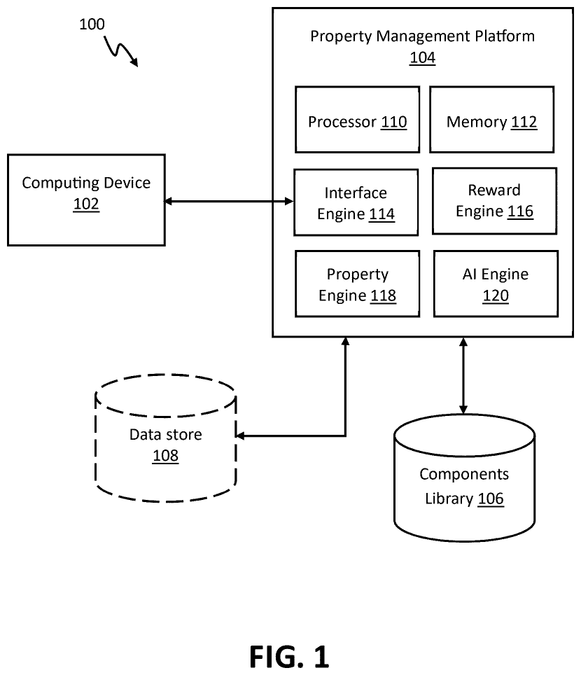

Referring to FIG. 1, a block diagram of system 100 for managing properties and tenants, according to an embodiment. System 100 generally comprises a computing device 102, a property management platform 104, a components library 106, and, optionally, a data store 108. System 100 is configured to, in one aspect, dynamically generating reward workflows. In embodiments, property management platform 104 is configured to interpret tenant data and property data to generate and execute a custom reward workflow.

Computing device 102 comprises an electronic device in communication with system 100. In an example, computing device 102 can be desktop computer, a laptop computer, tablet, mobile computing device, server, workstation, or Internet-of-things (IoT) device, among other electronic devices. Though depicted as protecting a single computing device, system 100 can, in other embodiments, include a plurality of computing devices 102, such as a networked system of devices. In embodiments, computing device 102 can be utilized by a user to interact with other components of system 100, such as property management platform 104.

Property management platform 104 generally comprises a processor 110, a memory 112, an interface engine 114, a property engine 116, a reward engine 118, and optionally, an artificial intelligence (AI) engine 120. Property management platform 104 generally provides centralized data management, automation of tenant concessions, robust analytic and reporting capabilities, and scalability. In examples, property management platform 104 is configured to capabilities to monitor and implement reward workflows, for example to retain tenants.

In some embodiments, as illustrated in FIG. 1, property management platform 104 is implemented on a single device, such as a server, having its own processor and memory. In embodiments, property management platform 104 can be a cloud-based service such that customization and execution of property management operations, such as reward workflows, can be distributed across a network of multiple computing devices (e.g., with each device having its own processor and memory).

Processor 110 can be any programmable device that accepts digital data as input, is configured to process the input according to instructions or algorithms, and provides results as outputs. In some embodiments, processor 1110 can be a central processing unit (CPU) configured to carry out the instructions of a computer program. Processor 110 is therefore configured to perform at least basic arithmetical, logical, and input/output operations.

Memory 112 can comprise volatile or non-volatile memory as required by the coupled processor 110 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the present disclosure.

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques.

An (e.g., each) engine can be realized in a variety of physically realizable configurations and should generally not be limited to any particular implementation exemplified herein, unless such limitations are expressly identified. In addition, an engine can itself be composed of sub-engines, each of which can be regarded as an engine in its own right. Moreover, in the embodiments described herein, each of the various engines corresponds to a defined functionality; however, it should be understood that in other contemplated embodiments, each functionality can be distributed to more than one engine. Likewise, in other contemplated embodiments, multiple defined functionalities can be implemented by a single engine that performs those multiple functions, possibly alongside other functions, or distributed differently among a set of engines than specifically illustrated in the examples herein.

Interface engine 114 provides input/output capabilities of property management platform 104. In some embodiments, interface engine 114 can comprise an interface, such as a graphical user interface, configured to display property management fields and schemas and to receive user input.

Interface engine 114 can include graphical or text-based interfaces for defining and designing reward workflows. For example, a user can define reward workflow components and declare their attributes through interface engine 114. In some embodiments, interface engine 114 generates monitoring dashboards (e.g., reporting tools and analytics capabilities) to track the performance, efficiency, and compliance of reward workflows across tenants.

In some embodiments, interface engine 114 integrates with other systems, applications, and databases, such as data store 108, to access data and exchange information. For example, interface engine 114 can send an indication of an earned financial reward to computing device 102. Connectors, APIs, and adapters can allow for interoperability.

Reward engine 116 (e.g., that may be referred to as an offer engine) supports reward workflow management and execution. For example, reward engine 116 is configured to declare inputs and associated attributes. For example, reward engine 116 can define a custom reward workflow to automate a loyalty program according to defined conditions. Components of a defined reward workflow can be manipulated by a user, for example a user of computing device 102, to efficiently adjust values of and/or associations between inputs (e.g., tenant actions) and outputs (e.g., a cash reward).

In some embodiments, reward engine 116 allows a user to enhance workflow components libraries, such as components library 106. In one aspect, enhancement of workflow components libraries can be performed using no-code or low-code programming techniques, such as visual development environments and predefined components and templates. A user-friendly approach to reward workflow development can empower property managers and organizations to create custom rewards programs tailored to particular properties and/or tenants.

In some embodiments, reward engine 116 is configured to progress reward workflows based on received data (e.g., via interface engine 114). For example, reward engine 116 can incorporate housing data associated with a first system and tenant data associated with a second system to determine whether a condition of a reward workflow is satisfied. Correlations, associations, and links between cross-system data can be defined by a user, for example via interface engine 114, or automatically determined, for example via AI engine 120.

In some embodiments, reward engine 116 is configured to report task progress and resource allocation. In one aspect, reward engine 116 can support dynamic reporting capabilities that consider factors such as task priority (e.g., impending lease dates), resource availability (e.g., funds available for reward programs), and process constraints (e.g., local regulations pertaining to sweepstakes). In another aspect, reward engine 116 can route reward workflow items to appropriate users or systems when enforcing conditions (e.g., process rules). For example, reward engine 116 can assign reward workflow inputs and/or outputs to users based on predefined criteria, such as a duration of a lease associated with a tenant, or a location of a property associated with a tenant. For example, reward engine 116 can perform action reassignment to ensure efficient reward distribution among tenants.

In some embodiments, reward engine 116 can support dynamic security and access control for reward workflows. Reward engine 116 can incorporate security policies, authentication mechanisms, and access controls to protect sensitive data and ensure compliance with regulatory requirements. Role-based security (e.g., based on user profiles), encryption, audit trails, and data privacy measures can be implemented according to embodiments. Reward engine 116 can implement administrative actions that are associated with an elevated access level. In examples, a non-administrative user can be limited to entering data while an administrative user can configure custom reward workflows. In some embodiments, access control can be based on available property data. For example, a tenant can lose access to a reward workflow upon expiration of a lease in the name of the tenant.

Property engine 118 is configured to process property data and notify reward engine 116 on condition detection. For example, property engine 118 can automatically monitor property data, for example provided by data store 108. In such an example, property engine 118 provides data relevant to the status and/or metadata associated with each reward workflow instance, allowing for real-time monitoring, reporting, and analysis.

In some embodiments, condition detection by property engine 118 is based on a comparison of attributes associated with a specified input and obtained property data. For example, a similarity search can be conducted to determine whether obtained property data is associated with a specific reward workflow.

In some embodiments, a user can provide property data to property engine 118 using computing device 102. In another embodiment, property engine 118 itself can actively gather or request event data from computing device 102.

AI engine 120 is configured to utilize AI models to develop reward workflow creation and implementation. For example, AI engine 120 can monitor the implementation of a reward workflow and log the details to improve system 100 effectiveness. Process metrics of reward workflow output can allow for automated improvement and optimization of property management platform 104 according to an embodiment.

In some embodiments, data associated with a reward workflow component (e.g., an input or output) can be stored in components library 106 such that statistics can be gathered for later monitoring and updating purposes. If a reward workflow component is not helpful (e.g., fails to improve tenant retention), the reward workflow component can be modified or removed from components library 106.

In an example, properties associated with reward workflow components can be updated for future reward workflows. In particular, AI engine 120 can implement a feedback loop where the outcomes of reward workflows (e.g., successful, partially successful, unsuccessful) are used to refine and improve workflow effectiveness. For instance, if a cash reward is common successfully in certain locations but not in others, AI engine 120 can learn to associate the applicability of the cash reward with specific geographic factors.

In another example, reinforcement learning can be used to implement a reinforcement learning model where AI engine 120 determines a recommended workflow component (e.g. the most effective output) based on indications of tenant retention received for implemented reward workflows. Over time, the model can optimize workflow component suggestions for various scenarios and properties, effectively learning from past actions.

In some embodiments, AI engine 120 provides automated data labeling. For example, if a reward workflow awards a cash amount, the reward workflow can be labeled with a financial tag. In another example, if a reward workflow limits rewards to a tenant's first year of occupancy, the reward workflow can be labeled with a new-tenant tag. Labeled data can be used by AI engine 120 to train AI models, improving future recommendations.

In some embodiments, property management platform 104 can be AI-enabled via AI engine 120 such that a specially trained AI algorithm can be embedded in or accessible to property management platform 104 to facilitate meaningful outputs, such as reward workflows.

With continued reference to FIG. 1, components library 106 comprises one or more storage repositories, such as a database, logical disk space, file, or other suitable storage medium configured to store workflow components (e.g., inputs, outputs, and conditions). In some embodiments of a database, components library 106 can be a general-purpose database management storage system (DBMS) or relational DBMS as implemented by, for example, ORACLE, IBM DB2, Microsoft SQL Server, PostgreSQL, MySQL, SQLite, LINUX, or UNIX solutions.

In some embodiments, components library 106 can be integrated with property management platform 104. For example, workflow components can be stored in memory 112. In embodiments, computing device 102 is provided access to all or a subset of data in components library, for example via interface engine 114.

Data store 108 generally comprises a database (such as those described with respect to components library 106). In some embodiments, data store 108 is configured to store parameters or attributes corresponding to properties, including occupancy data. Property management platform 104 can communicate with data store 108 to request data used by property engine 118 to detect conditions.

Generally, in operation of system 100, computing device 102 is used to interact with property management platform 104 via interface engine 114 to facilitate the creation and implementation of rewards programs. In particular, reward engine 116 can track dynamic workflows based on tenant data and/or property data provided by data store 108 and/or computing device 102. AI engine 120 can recommend improvements to the reward workflow, such as suggesting values of outputs (e.g., rewards) based on available resources (e.g., a current marketing budget). Once a workflow is generated, property engine 118 can detect conditions and implement workflow operations.

In some embodiments, property management platform 104 provides dynamic recommendations by performing one or more of the following. Interface engine 114 obtains input data associated with renter attributes (e.g., renter behavior) and/or property attributes (e.g., occupancy), for example from computing device 102 and data store 108. Property engine 118 determines whether the obtained input data satisfies a condition of a reward workflow. Reward engine 116 determines an output associated with the input data and/or determined condition status, for example, based on a created reward workflow. Reward engine 116 performs the output and/or recommends an action to be taken. In some embodiments, property management platform 104 generates a report including an indication of the recommended action to be taken. In some embodiments, the recommended action can be predefined, for example based on a mapping of conditions to actions. In some embodiments, the recommended action can be dynamically generated, for example, by AI engine 120 based on previous actions taken for the condition or similar conditions.

In one aspect, the report can include a recommendation (e.g., of an action to be taken) to a property manager (e.g., landlord). For example, the recommendation can be based on input data collected across a group of renters associated with a property owned by the property manager. For example, the recommendation can be to provide a cash reward to a renter.

In a second aspect, property management platform 104 can provide a recommendation (e.g., of an action to be taken) to a renter. For example, the recommendation can include the renter setting a goal. In such an example, interface engine 114 can cause computing device 102 to present the renter with a user interface configured for the renter to identify/set the goal. If desired, the user interface can permit the renter to select a goal from a predetermined selection of goals. In some embodiments, responsive to the renter setting the goal, property management platform 104 can send the renter information on how to help achieve the goal.

In some implementations, the input data can include an indication that a renter did not pay rent on time. Referring to the previous example, a goal suggested to or selected by the renter can include paying rent on time in the future. The property management platform 104 can send educational resources or other information to a computing device 102 associated with the renter (e.g., based on a log in) to help the renter to save money. In some embodiments, the renter can be provided with a cash reward for setting the goal. In accordance with the embodiment, the renter can be provided with a further cash reward for saving money, making an on-time rental payment, or for taking other actions, such as steps identified by the educational resources.

In a third aspect, property management platform 104 performs an action associated with a satisfied condition. For example, reward engine 116 can automatically provide a predefined cash reward to a renter for performing an action. In such an example, property engine 118 can verify whether the action was satisfactorily performed based on a comparison of the received input data to an expected value and/or a value provided by an external data store, such as data store 108.

In some implementations, the input data can include financial data associated with a renter. For example, the input data can include financial data extracted from digitized financial transaction information provided by the renter. For example, the financial data can include vendor information, a purchase made by the renter (e.g., that identifies a vendor), and/or information that identifies an item purchased by the renter (e.g., stock keeping unit (SKU) information). In such examples, property management platform 104 can, based on a created reward workflow, provide a cash reward to the renter in the form of a gift card for use with a vendor selected based at least in part on the obtained financial data.

Property management platform 104 can be configured, for example, to provide recommendations based on interpreted financial data. For example, Property management platform 104 compares a price paid by a renter for a good or service to similar offerings. If lower-priced, comparable services or goods are identified, a notification can be sent to the renter, altering them of the better deal (e.g., for the next time they make such a purchase). Further, property management platform 104 can lookup potential savings (e.g., discounts and coupons) for vendors that a renter frequents (e.g., based on financial information associated with the renter's shopping patterns), and can forward the potential savings to the renter.

In some embodiments, a reward workflow can be based on financial data associated with a renter. For example, shopping patterns can be analyzed to determine which discounts or incentives a renter is likely to prefer.

Property management platform 104 obtains and manages tenant data and/or property data. In embodiments, property management platform 104 obtains tenant data and property data, for example, using one or more of: user input (via interface engine 114); interaction analytics (e.g., user interactions when using property management platform 104); tracking technologies, such as cookies; APIs and integrations with external platforms and/or data providers (e.g., data store 108); or scraping and web crawling techniques.

In embodiments, tenant data encompasses various types of information related to individuals or entities renting or leasing properties. Tenant data can include, for example, one or more of: financial data, social data, geographic data, and tenant goals.

In some embodiments, tenant data comprises financial data. Financial data associated with a tenant can include, for example, data pertaining to: income, occupation (e.g., employment), banking, payment history (e.g., rental payment history), purchase history, insurance, and creditworthiness (e.g., credit score). Security and confidentiality are paramount when handling financial data of a tenant, for example, to ensure compliance with privacy laws and regulations. In embodiments, user financial data can be anonymized. For example, financial data can be stripped of personally identifying information and trends of aggregated, anonymized financial data can be used to inform and/or recommend reward workflows.

In some embodiments, financial data associated with a renter can be extracted from digitized financial transaction information (e.g., as previously described). For example, the financial data can include vendor information for a purchase made by the renter that identifies the vendor and stock keeping unit (“SKU”) information that identifies at least one item purchased by the renter.

In some embodiments, tenant data comprises social data. Social data can pertain to the tenant's current living arrangement, interests, purchases, interpersonal relationships, and the like. In examples, social data associated with a tenant is extracted or otherwise obtained from social media. For example, social data extracted from a social media platform can be parsed by property management platform 104 (e.g., interface engine 114, property engine 118). For example, social data can be provided by a social media platform via access to a data store 108 associated with the social media platform.

In some embodiments, tenant data is associated with tenant behavior. For example, a renter can be encouraged to form a social media platform connection (e.g., accept a request to associate or follow) with a rental management company that manages the renter's apartment building. Property management platform 104 can periodically query the social media platform (e.g., a page/profile of the renter or the rental management company), and/or parse push notifications from the social media platform to obtain social data associated with the renter. Property management platform 104 evaluates/interprets the social data to identify an interest of the renter, according to embodiments.

In some embodiments, tenant data is associated with geographic information. Property management platform 104 can parse geolocation and/or timing coordinates of photos uploaded by a tenant to a social media platform to identify the location and time the photo was taken. For example, property management platform 104 can evaluate metadata associated with an uploaded photo. For example, property management platform 104 can interact with an API or other interface of the social media platform to obtain social data. The structure of social data, for example fields, parameters, and/or attributes associated with user activity can be appreciated through APIs and other materials provided by the social media platform. For example, if a renter posts a photo of the renter at a restaurant, property management platform 104 can parse the social media post text for a text notation. The text notation can indicate information about the photo, such as the renter naming the restaurant. If sufficient detail is not provided in post text, property management platform 104 can analyze the photo for embedded geo coordinates and/or time stamp information (e.g., metadata). Property management platform 104 can correlate the geo coordinates with a map indicating vendors in that location.

In embodiments, property management platform 104 can aggregate social data when determining a property of social data. With continued reference to the previous example of a posted photo, if predefined or contextually informed keywords (e.g., dinner or meal) are detected in post text, property management platform 104 can determine, based on the detected keywords and geo coordinates, that the renter is located at a particular restaurant.

Property management platform 104 leverages tenant data, including social data, to determine a reward or reward workflow, according to embodiments. In embodiments, social data, such as the presence of a renter at a restaurant, can be used by property management platform 104 to predict an interest of a renter (e.g., a type of cuisine). For example, property management platform 104 can send the renter a reward in the form of a gift card or discount for the restaurant or a similar restaurant (e.g., a preferred provider offering the type of cuisine).

In embodiments, property management platform 104 determines associations between tenants, for example based on social data, such as a tenant's friend's list. The friend list can be cross-referenced to data store 108 (e.g., a public database) by property management platform 104 to determine social information of other tenants or individuals associated with the tenant. For example, property management platform 104 can access/ping a phone number database to identify an address associated with a friend of the tenant. By determining the address information, property management platform 104 can identify which of the tenant's social media friends live in rental buildings and/or characteristics of a building associated with the address, such as number of floors or presence of amenities (e.g., a pool, parking lot, etc.).

Property management platform 104 can, based on social data and other tenant data and/or property data, perform a recruitment/referral operation associated with a reward workflow. In a first aspect, property management platform 104 makes a recommendation to a tenant to refer a friend to apply for an apartment that is becoming available. If the tenant sends an invitation to the friend, the system can reward the tenant and/or friend. In a second aspect, property management platform 104 offers a reward to a tenant for providing property management platform 104 with contact information of a friend. The timing of the offer and/or the reward can be based on social data, for example. In a third aspect, property management platform 104 asks a tenant to send a message (e.g., an invitation) to a friend through a social media platform to make the friend aware of an available apartment. If the friend moves in after signing a lease, property management platform 104 can recommend the renter give the friend a welcome gift. Accordingly, social data, for example from social media platforms, can be leveraged to identify and capitalize on connections between a renter and their contacts. For example, close contacts of the renter may be suitable and reliable tenants. Moreover, having a renter's friends or connections in the same apartment complex fosters a sense of community and is likely to encourage the tenant to stay in the apartment, reducing the risk of the apartment becoming unoccupied.

In examples, a recruitment/referral action can be incorporated into a reward workflow. In such examples, reward engine 116 can provide a tenant with a reward for satisfying conditions associated with the recruitment/referral action (e.g., as determined by property engine 118). For example, the reward workflow can specify a first reward for an initial referral, a second reward for the friend touring the apartment, and a third reward if the friend signs a lease. In examples, a single reward can scale as conditions are satisfied (e.g., rather than separate rewards for each satisfied condition).

In some embodiments, tenant data comprises geographic data. Geographic data associated with a renter can include geographic information, for example, indicating routes travelled and/or places visited. For example, geographic data can include a place, such as a store, frequented by a renter. Geographic data can be used to supplement financial data and/or social data, for example, to identify rewards that are of interest to a particular renter or set of renters.

In examples, property management platform can recommend a business to include in a property (e.g., commercial space on a ground floor) to a property manager (e.g., of a mixed-use space). A recommendation of a business to include in a property can be based on a location type (e.g., gym, restaurant, hairdresser) frequently visited by renters of the property or similar properties. A location type can be of varying granularity. For example, a location type can be as specific as a particular store or brand, or as broad as a general service type offered by locations, such as healthcare services.

In some embodiments, tenant data comprises tenant goals. Tenant goals can refer to goals provided by tenants to property management platform 104, such as financial goals, property goals (e.g., moving within a property, desired features/improvements of a property), and life goals. For example, tenant-indicated financial goals can include short-term plans to save or long-term plans to invest. Additionally, tenant-indicated goals may include price such as what the tenant can afford, which may be subject to pricing changes while being a tenant. For example, property goals can include a desired location or experiential goals such as view or amenities. For example, life goals may include life-events including marriage, a job change, and birth of children, among others.

In embodiments, tenant data is leveraged by property management platform 104 when making determinations and/or recommendations. For example, property management platform 104 can use tenant data to determine whether a condition associated with a reward workflow is satisfied. For example, property management platform 104 can use tenant data to tailor reward workflows to specific tenants or sets of tenants.

In some embodiments, property management platform 104 is configured to generate a tenant profile, based at least in part, on tenant data associated with a tenant. The tenant profile can comprise one or more attributes associated with a tenant as derived from tenant data. For example, a tenant attribute is that the tenant as a high-wealth individual, for example, based on financial data. For example, a tenant attribute is a location associated with the tenant, such as a location of the building the tenant currently occupies or a location where the tenant works. For example, a tenant attribute is the gender identity of the tenant.

In some embodiments, tenant attributes can include, for example, one or more of: rent for a residence of the tenant; the per square cost for a residence of the tenant; delinquency rate of the tenant; the end date of a lease for a residence of the tenant; or how when the tenant signs a lease renewals (e.g., how soon before lease expiration the lease renewal is signed).

In some embodiments, tenet profiles are used for accessing property management platform 104. For example, an access level to features provided by property management platform 104 can be associated with a tenant profile. For example, a tenant profile can be used to associate a computing device 102 with a tenant.

Incorporation of tenant profiles and attributes based on tenant data facilitates reduced complexity and efficiency of reward engine 116, for example when generating reward workflows. For example, tenant profiles can be associated with one another based on a comparison of attributes. In an example, a set of tenants can be quickly selected using a desired attribute, such as all of the tenants within a building or all tenants with an impending lease expiration. Reward engine 116 can allow for sets of tenants to be quickly defined and/or updated as tenant attributes change, simplifying the user experience of property managers.

Property management platform 104 is configured to derive/determine demographic indicators and trends based on tenant data and/or tenant profiles. Demographic trends can be determined, for example, through comparisons to historical data (e.g., property history). A demographic trend determined by property management platform 104 can be based on an observed behavior or a behavioral change of similar tenants. For example, if properties in a certain area begin filling with tenants identified as high-wealth individuals, property management platform 104 can notify property managers of a determined trend that the area is in high demand with such tenants.

Property management platform 104 can provide demographic indicators and trends within tenant data to property managers, allowing for valuable insights into the characteristics, preferences, and behaviors of their tenant population. Further, this information can inform strategic recommendations (e.g., by AI engine 120) for reward workflows and marketing strategies to better meet the needs of tenants and optimize property management practices.

Property management platform 104 is configured to derive/determine a desirability rating of a tenant based on tenant data and/or tenant profiles. The desirability rating of a tenant is a metric, or score used by landlords or property managers to assess the attractiveness or suitability of a tenant for a rental property. In examples, a higher desirability rating indicates that a tenant is more likely to be responsible, reliable, and low risk, while a lower desirability rating signals potential concerns or risks associated with the tenant.

The desirability rating can be based on various factors related to the tenant's financial stability, rental history, behavior, and overall suitability as a tenant. In examples, the desirability rating can be based on objective criteria, such as credit scores, income levels, rental payment history, employment status, and background checks. In examples, the desirability rating can be based on subjective factors, such as references from previous landlords, and personal interviews.

For purposes of illustration, and not limitation, input to property management platform 104, such as tenant data, can affect a desirability score of a tenant. For example, in one illustration, property management platform 104 determines the tenant data associated with a renter evidences the renter did not pay rent on time. For example, this determination can be based on property management platform 104 monitoring a data store 108 or an external application, such as a management company's bank account, a property rent roll report, or other system. Interface engine 114 and property engine 118 can query account information from a property owner's bank account and parse the information to search for an incoming payment that bears an indication of a particular renter's checking account (e.g., that has previously been used to pay the rent). Failure to detect such a transaction within a predetermined time period, such as several days, of a rental payment deadline can automatically trigger property management platform 104 to prepare and send a message (e.g., email, SMS text, or the like) to the tenant informing them that their rent was not received on time. In examples, the message can provide one or more recommendations to help the renter manage their finances to help avoid being late in future payments.

In examples, the desirability rating can be used, for example, to inform recommendations regarding one or more of: tenant screening, lease negotiations, rent adjustments, maintenance priorities, renewal incentives, marketing, and risk management. In embodiments, reward engine 116 generates reward workflows based on the desirability rating of a tenant or set of tenants.

Property managers can manage risk through better turnover understanding by implementing strategies to reduce vacancy periods, minimize turnover costs, and attract high-quality tenants based on tenant data. For example, when a property owner raises capital, property management platform 104 can be used to show that the property owner has a granular understanding of tenant turnover, presenting a lower risk investment to a potential lender.

In some embodiments, property management platform 104 can suggest proactive lease renewal strategies and tenant retention programs through reward engine 116 based on tenant data. Reward engine 116 can incorporate reward workflows directed to incentives for renewing leases (e.g., early lease renewal offers), loyalty rewards, or amenity upgrades. Implementing effective reward workflows can induce long-term lease commitments and reduce tenant turnover, for example by incentivizing tenants to accrue rewards over time.

In some embodiments, tenant data can be used by property management platform 104 to build tenant relations. Building strong relationships with tenants can encourage them to stay longer and reduce turnover. Open, proactive communication and recommendations through interface engine 114 can allow property managers to communicate with their tenants effectively and unobtrusively. Further, property management platform 104 provides a clear contact point for tenant needs and comments, such as communicating maintenance issues.

Interface engine 114 can recommend relevant resources to tenants based on tenant data. Providing tenants with resources and information about lease terms, property policies, and community amenities can improve their understanding and satisfaction. Further, property management platform 104 can identify common areas of confusion for tenants and recommend property managers offer orientation sessions, online portals, and informational materials directed to the area of confusion. In examples, interface engine 114 can provide periodic surveys, satisfaction assessments, and community forums to tenant computing devices 102, allowing property management platform 104 to better identify areas for improvement.

In some embodiments, AI engine 120 can process communications from tenants to dynamically prioritize property tasks. For example, AI engine 120 can determine the priority of a maintenance issue based on keywords and message characteristics (e.g., time of message, frequency of messages, length of message). For example, if a tenant provides frequent messages reporting a maintenance issue late at night, AI engine 120 can determine label the maintenance issue to be a high priority.

In embodiments, property data encompasses various types of information related to properties and property markets. Property data can include, for example, market data and attributes of owned properties.

In some embodiments, property data comprises market data. Market data, as used herein, refers to information and statistics related to the real-estate market and/or rental market, including trends, performance indicators, and metrics. Market data can include, for example, one or more of: sale prices, rental rates, rental yields, vacancy rates, inventory levels, and price/rate trends over time. In examples, property management platform 104 can generate price comparisons across neighborhoods or regions based on market data.

In some embodiments, reward engine 116 can generate reward workflows based on market data. For example, in the instance of a lease coming up for renewal, the value or amount of a reward, such as a cash reward, can be set based on market conditions. In one instance, if the building is in high demand area, reward engine 116 can recommend to not entice an existing tenant to stay, for example, if tenant data indicates the existing tenant does not want to or cannot pay a higher rent. In a second instance, if there are a significant number of empty units on a property, or if it is a time of year that is difficult to obtain a reliable tenant (e.g., wintertime) a reward can be recommended to encourage tenants to stay on the property. In such an example, reward engine 116 can recommend a reward that is relatively significant in magnitude (e.g., to reflect the comparatively high cost of acquiring a new tenant).

In some embodiments, property management platform 104 conducts regular market analyses to determine local rental trends, demand dynamics, and competitive rental rates. Market data can be provided to property owners via interface engine 114 and/or incorporated into recommendations generated by property management platform 104. By pricing units competitively and adjusting rents strategically, property owners can minimize vacancies and turnover while maximizing rental income.

In some embodiments, property data comprises property attributes. Property attributes can include, for example, one or more of location, size (e.g., number of units, square feet), property type (e.g., residential, commercial), condition, current tasks (e.g., maintenance needs), amenities, utilities, financial performance, and occupancy. Maintaining state information about property attributes and factors, for example at components library 106 and/or data store 108, allows property management platform 104 to customize and optimize recommendations and reward workflows for particular property owners.

In some embodiments, recommendations generated by property management platform 104 can be based on geographic data associated with a property and/or perspective property. For example, a recommendation to a prospective property manager can include highly trafficked locations for a particular subset of renters (e.g., a demographic) to inform future property developments.

In some embodiments, workflow management platform 104 is configured to, via property engine 118, interpret the concession spend of properties (e.g., properties in the market, properties across a property portfolio) to derive recommendations. In examples, workflow management platform 104 compares metrics from a set of properties to a particular property, such as a user's property with similar property attributes as the set of properties, to evaluate property status and performance. Comparable properties can be selected for comparison with a user's property based on one or more metrics including, for example, one or more of: the amount of rent for the property or for units within the property; the location of the property; the type of property (e.g., multi family dwelling, single family dwelling, apartment building, and the like); and the property class (e.g., Class A, Class B, Class C). Workflow management platform 104 can compare (e.g., via reward engine 116 and property engine 118) the value of rewards (e.g., incentives or concessions) for a user's property to the value of rewards at comparable properties. Accordingly, property spend comparisons can be used to automatically recommend suitable spending levels for reward workflows for a given property. Property management platform 104 allows for ongoing refinement of the magnitude of cash back offers for a user's property, or for client(s) of the user, which may be property managers or owners, for example.

Property management platform 104 is configured to perform data acquisition. Data can be acquired, for example, through one or more of: data entry, importing, or integration. In examples, property management platform 104 can store acquired tenant data and property data. For example, property management platform 104 can store tenant data and property data in cloud-based storage solutions or data warehouses, enabling secure, scalable, and accessible data storage. Cloud-based platforms offer flexibility, reliability, and data redundancy, ensuring data availability and integrity. In examples, Property management platform 104 is configured to provide data migration services to assist users in transferring existing tenant and property data from legacy systems or manual records to component library 106 and/or data store 108. Data migration services ensure a smooth transition to the new platform while preserving data integrity and completeness.

In some embodiments, property management platform 104 can obtain data from data entry through one or more interfaces, for example tenant and management interfaces supported by interface engine 114. In examples, property managers or administrators can manually enter tenant and property data into component library 106 and/or data store 108 through user interfaces (e.g., GUIs), forms, and/or surveys. In examples, property management platform 104 provides tenant portals or self-service options that allow tenants to input and update their personal information, lease details, maintenance requests, and payment preferences directly into the platform. Tenant self-service features enhance convenience, transparency, and data accuracy.

In some embodiments, property management platform 104 allows importing of existing tenant and property data from external sources, such as spreadsheets, databases, or other software applications. Data import functionalities streamline the onboarding process and ensure data consistency and accuracy. In examples, property management platform 104 integrates with external property data systems, for example through APIs. For example, property management platform 104 can integrate with third-party service providers, such as tenant screening agencies, credit bureaus, background check providers, and utility companies, via APIs. Integration enables seamless data synchronization and real-time updates between systems, eliminating manual data entry and reducing data duplication. In some examples, property management platform requests access for tenant data that is exclusively stored by third parties, for example, to comply with regulations.

In some embodiments, property management platform 104 automatically monitors data by integrating with IoT (Internet of Things) devices, sensors, or smart home technology installed in properties. Automated data collection systems can gather information on property conditions, energy usage, security incidents, and maintenance needs in real-time.

In some embodiments, property management platform 104 performs data aggregation to access external data sources, such as property listings, market research reports, demographic data, and regulatory information. During data aggregation, property management platform 104 can consolidate data from multiple sources into a unified format.

In some embodiments, property management platform 104 uses scraping and web crawling techniques (e.g., as described with respect to social data) to obtain tenant data and/or property data. For example, web crawling and scraping of property data can involve automated processes for extracting information from websites, databases, or online sources related to real estate listings, property details, market trends, and other relevant information. Web crawling involves systematically navigating through web pages to discover and collect data. A web crawler recursively follows hyperlinks present in a list of seed URLs to visit additional pages. The crawler retrieves the HTML content of each page and extracts relevant information based on predefined criteria. Data extraction involves extracting structured data from the parsed HTML content. Extracted data is then transformed into a structured format, such as JSON or CSV, for further processing and analysis. In examples, property management platform 104 can normalize extracted data.

In further accordance with the disclosure, property management platform 104 can implement natural language processing (NLP). NLP techniques allow property management platform 104 to process large volumes of natural language data, extract insights, and perform tasks such as text classification, sentiment analysis, and language translation. For example, chatbots employing NLP technology can be used for message monitoring and routing so as to classify a message and route it to the right person based on contextual details, such as message keywords. NLP can also be used for dialogue generation, such as for generating responses to tenant queries or concerns, or to ask questions to solicit further input from a tenant.

In some embodiments, NLP can be used for data mining, such as for analyzing user sentiment on a topic by scraping social data from a user's social media posts or comments. NLP can be used for language and dialect detection, such as to build chatbots whose speech/text patterns change dynamically in response to detecting the language, dialect, and/or grammar input by a user.

NLP can be leveraged to determine tenant satisfaction through sentiment analysis of user input. For example, interface engine 114 can determine a sentiment or emotional tone expressed in text, such as positive, negative, or neutral sentiment. Application of NLP to interface engine 114 can facilitate feature(s) provided herein, such as maintenance task prioritization and/or reward workflow escalation.

NLP algorithms and models employed by property management platform 104 can be powered by ML and deep learning techniques, such as neural networks. In examples, NLP models are trained on datasets of annotated or labeled text data within components library 106 to recognize patterns.

In further accordance with the disclosure, property management platform 104 uses computer vision (CV) to analyze images to extract useful content. The disclosed embodiments can use CV, for example, to extract property information from pictures, such as estimating the state of disrepair for a property by looking for staining on exterior or interior surfaces, cracked tiles, bricks, floors or driveways, chipped paint and wood, overgrown landscaping and the like. CV can also be used, for example, to estimate square footage or rendering 3D models from property photographs. CV can be used to extract biometrics and vitals from footage. For example, facial recognition can be used to identify a user of a computing device or permit entry into a room. CV can be used, for example, as optical character recognition (OCR) for parsing and/or digitizing physical documents.

Interface engine 114 facilitates user interaction with property management platform 104 by generating and otherwise providing user interfaces. In one implementation, user interfaces can include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. In another implementation, such user interface elements may include sounds (e.g., event notification sounds stored in MP3 file format), animations, vibrations, and/or the like that may be used to inform the user regarding occurrence of various events.

In various implementations, interface engine 114 is configured to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, GUIs generated by interface engine 114 incorporate interface elements, such as widgets via a widget toolkit. In some implementations, the interface engine 114 incorporates information presentation capabilities provided by other engines of system 100.

In some embodiments, an interface generated by interface engine 114 comprises a resident interface. The resident interface is configured to allow users (e.g., renters) to join a loyalty program associated with one or more reward workflows generated by reward engine 116. Property engine 118 can track various parameters of the renter over time, for example, to determine whether condition(s) associated with a reward workflow of the loyalty program are met. Interface engine 114 can receive tenant data as input from the renter. User input, for example, requested by interface engine 114 can include custom parameters of a reward workflow. The custom parameters can be specified by an administrative user (e.g., a property owner or manager) and can include, for example, one or more of: employment status, employer, financial goals, and particular amenities of interest, target rental price, family status, and long-term life goals. Such custom parameters can be integrated into reward workflows by reward engine 116 and/or stored in components library 106.

In some embodiments, a resident interface includes a reward interface that is generated based on an associated reward workflow. The reward interface can include interface elements tailored to workflow components of the associated reward workflow. For example, the interface elements can be configured to manage earned rewards, display progress towards future rewards, and identify conditions of the associated reward workflow. Incorporation of property data and tenant data by reward engine 116 allows for aligning property attributes (e.g., amenities, resources, marketing budget) with tenant attributes (e.g., income, goals). Reward engine 116, and accordingly a reward interface associated with a reward workflow generated by reward engine 116, can prioritize units, offers, and incentives to maximize tenant engagement with property management platform 104. By assessing the needs of the various renters in a loyalty program and possible incentives available (e.g., within an associated reward workflow), reward engine 116 dynamically matches a renter with a customized reward. The customized reward (e.g., generated incentives, and/or incentive options) can be presented to the renter via a GUI of the resident interface (e.g., a reward interface). The disclosed implementations can generate and recommend different Cash Back offers to some or all applicants depending on criteria of the property and the market. For example, cash back offers can be based on the day, week, time of year, apartment unit type (1 bed, 2 bed, etc.) and the like.

In some embodiments, the resident interface generated by interface engine 114 comprises financial interface elements. Users (e.g., tenants) can use the financial elements to initiate or progress reward workflows. For example, renters can use the resident interface to transfer funds from a rewards account (e.g., with the owner/managing organization of a property) to an outside bank or digital wallet. For example, renters can use the resident interface to associate reward funds with a goal. As such, the resident interface can receive financial information on investment accounts, outside banks, and/or digital wallets associated with a particular user as input (e.g., from the user). The resident interface may allow the users to transfer funds from a real-estate investment portfolio, in a cryptocurrency, to a different investment in a non-digital currency and/or a cryptocurrency, and/or to transfer funds from their real-estate investment portfolio to a financial institution.

In some embodiments, the resident interface can incorporate AI engine 120. For example, the property management interface can display recommendations from AI engine 120 to a user (e.g., renter) based on ML. For example, based on user inputs, such as family size, job, career goals, education, and lifestyle preferences, ML can make recommendations on how to use income or suggest educational resources.

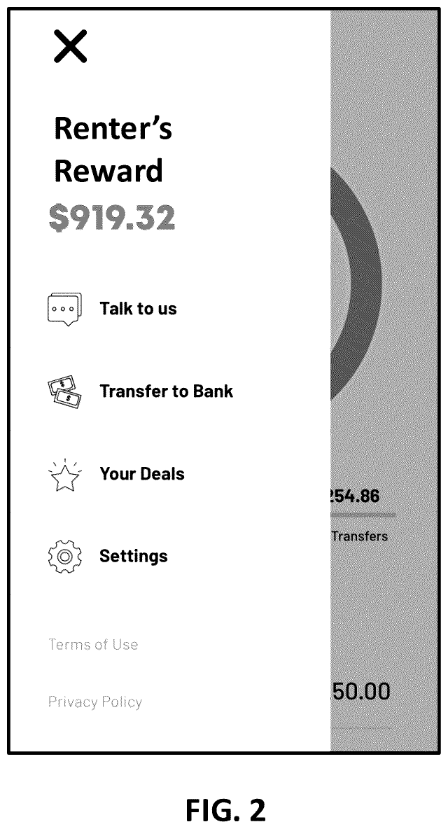

FIGS. 2-8 depict illustrative implementations of resident interfaces (e.g., GUIs, reward interfaces) that can be generated by interface engine 114, according to embodiments. In some implementations, a renter may interact with a property management platform (e.g., property management platform 104) using one or more of the example GUIs depicted in FIGS. 2-8. For example, interface elements (e.g., fields, buttons, etc.) can be provided in the GUI to receive user input.

FIG. 2 is an example GUI representing a landing page or main page that a renter can interact with, according to an embodiment. A main menu is provided that includes an amount of cash rewards in the user's account. The cash rewards in the user's account can be moved to an external financial institution. The cash rewards in the user's account can be added to from an external financial institution (e.g., to supplement the cash rewards in order to make a rent payment with the cash rewards). Cash rewards can be deposited in the user's account automatically by the property management platform or manually by an administrative user (e.g., a landlord or property manager). In examples, the property management platform can prompt an administrative user to deposit a cash reward based on the progress of a reward workflow (e.g., satisfaction of a condition). A menu selection interface element (e.g., “Talk to us”) is provided via the property management platform to permit the user to contact management. A menu selection interface element (e.g., “Transfer to Bank”) is provided to permit the user to perform a transfer, such as automated clearing house (ACH), to or from a financial institution. A menu selection interface element (e.g., “Your Deals”) is provided to provide the renter with one or more rewards or deals. The rewards or deals can be static or can be updated. In examples, particular deals can be curated for the user by reward engine 116 based on their preferences and other suitable permissible metrics that the system collects over time.

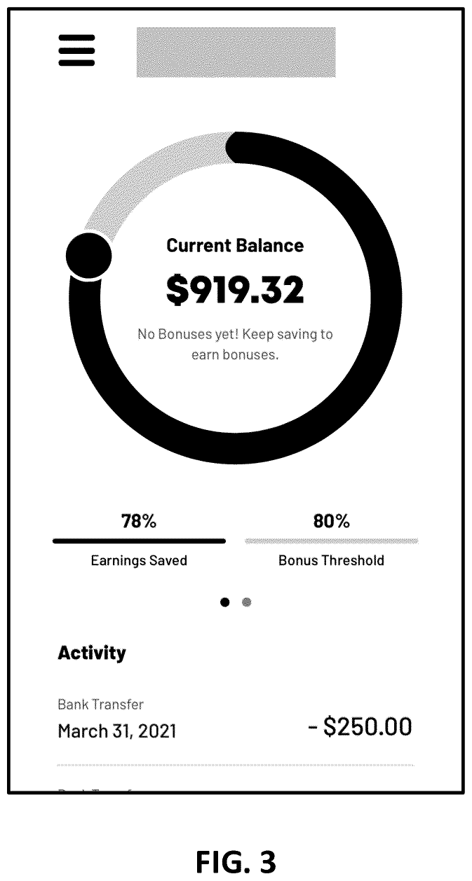

FIG. 3 is an example GUI representing a rewards interface with financial interface elements that can be displayed, for example, if a user selects the “Transfer to Bank” interface element of FIG. 2. As illustrated, an indicator is provided indicating the amount of money in the cash reward account. In examples, the indicator can be customized by interface engine 114 based on tenant data, property data, and/or a reward workflow. For example, the amount forming the scale of the interface element (e.g., the relevant amount required for the current balance to complete the circle) can correspond to a savings goal of the renter, such as the amount of one month's rent, and once a full month's rent is saved, the system can provide the renter with a further cash back reward. A bonus threshold can be for a proportion of a total goal amount, as illustrated in FIG. 3 as 80%. Embodiments of the disclosure provide for automated determination and implementation of customized reward workflows that can be incorporated into reward interfaces, such as the example depicted in FIG. 3.

With continued reference to FIG. 3, a central interface element is illustrated that indicates the amount of cash rewards the user has retained in their account on property management platform 104. A transaction history is provided at the bottom of the GUI of FIG. 3, indicating recent transactions.

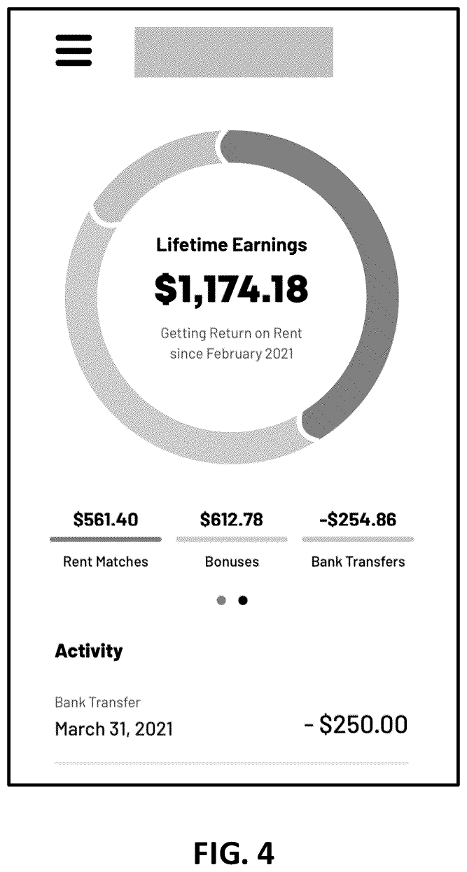

Referring to FIG. 4, an example reward interface is depicted, according to an embodiment. The reward interface can include an interface element illustrating a breakdown of money that has flowed through the user's account, including rent matches, bonuses, and bank transfers.

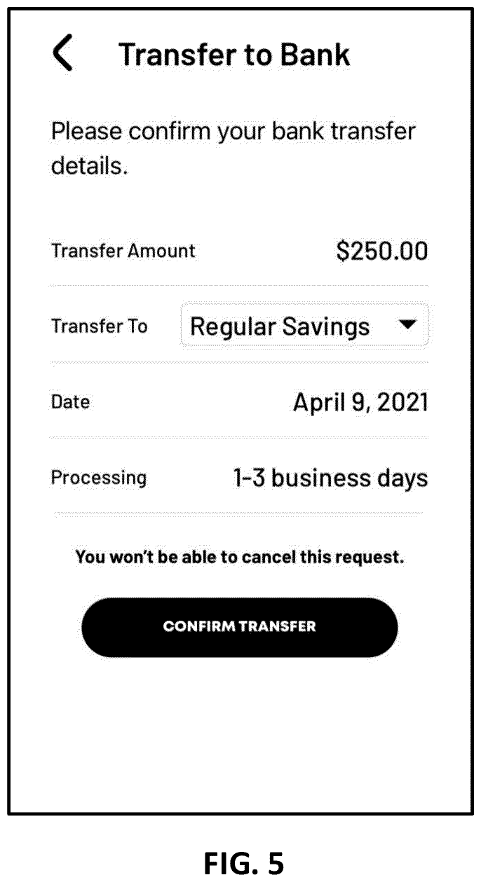

Referring to FIG. 5, an example resident interface for processing a bank transfer from the renter's cash reward account to an outside financial institution is depicted, according to an embodiment.

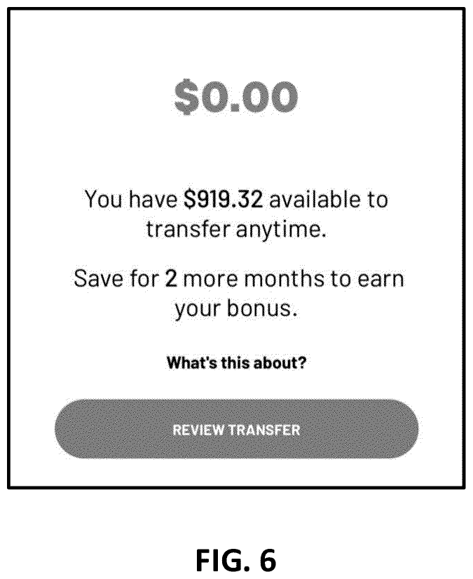

Referring to FIG. 6, an example resident interface providing an automated report is depicted according to an embodiment. As illustrated, the report can summarize the amount in a cash reward account of a renter and can inform the renter how many months the renter must save to obtain a bonus cash reward in their account (e.g., as a reward for consistent saving). In such an example, reward engine 116 can automatically determine the saving duration (e.g., a condition) as part of a dynamically generated reward workflow. For example, reward engine 116 can determine the duration of saving required before a reward based on tenant data associated with the renter. In some implementations, AI engine 120 can implement improvements or generate recommendations to the reward workflow (e.g., as described herein).

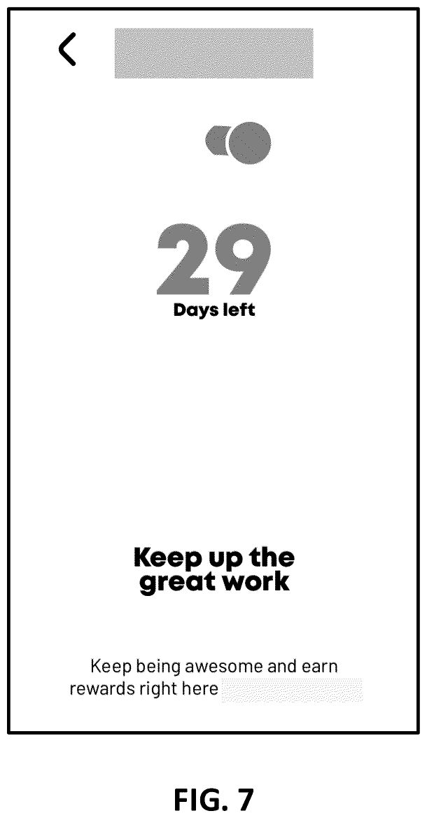

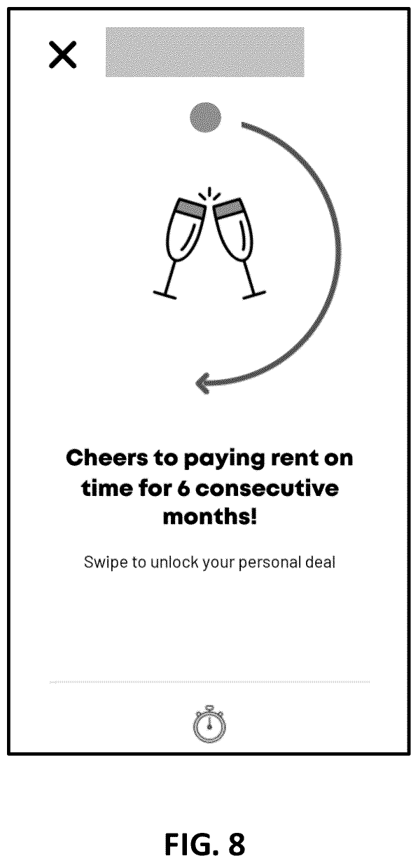

Referring to FIGS. 7-8, example reward interfaces illustrating progress of a savings goal (e.g., reward workflow conditions) are depicted, according to embodiments. FIG. 7 depicts interface elements indicating that a renter is closer to their savings goal, and FIG. 8 depicts interface elements indicating that a renter has achieved their saving goal, resulting in a reward. In some implementations, the reward can be dynamically determined at the time of grant (e.g., upon satisfaction of a workflow condition). This reward structure allows increased relevance of rewards to the tenant's current situation and environmental conditions (e.g., time of year). For example, a reward such as access or membership to an outdoor pool can be an effective reward in the summer but ineffective in the winter.

In some embodiments, an interface generated by interface engine 114 comprises a property management interface (e.g., property partner interface). The property management interface is configured to allow users (e.g., property partners such as property owners, property managers, and other administrative users) to access, specify, and monitor property attributes (e.g., building and community information) of one or more properties using property engine 118. The property management interface can include interface elements to configure a reward workflow using reward engine 116. These interface elements can be referred to as an offer manager. The property management interface allows users to manage the rental experience with property management functions such as amenities, tenant requests, fixing broken equipment or damage in the apartment, moving preferences, services such as laundry, pet care, cleaning, etc.

In some embodiments, a property management interface can include interface elements configured to interact with reward workflows (e.g., rental concessions, discounts, marketing offers), tenant attributes, and property attributes (e.g., pricing, amenities, maintenance requests). Incorporation of property data and tenant data by reward engine 116 allows for prioritizing units, offers, and incentives through alignment of property attributes (e.g., financials, amenities) to be with tenant attributes. Reward workflow management and generation options can be presented to property partners via an offer manager (e.g., graphical user interface) of the property management interface.

In examples, a magnitude of the recommended reward can be based at least in part on tenant data collected about a particular renter or other renters in the building. For example, if historically, only a reward above a certain magnitude was sufficient to entice a tenant to renew their lease during a given time of the year, the renter can be provided with an amount above that amount. Similarly, if the renter is off-cycle (e.g., the renter's lease begins and ends at an uncommon time, such as the middle of winter) property management platform 104 can recommend an extension be offered in the lease to permit the tenant, and the landlord, to be “on cycle” (e.g., end during a period when more renters are generally looking for a new rental unit).

In some embodiments, a property management interface generated by interface engine 114 comprises pricing elements. The pricing elements are configured to allow users (e.g., property owners and administrators) to manage property performance and pricing (e.g., rental rates) across a real estate portfolio. The property management interface can be associated with property engine 118, for example, to track renter payments and prices. Property engine 118 can derive recommendations based on monitored property data. For example, property data associated with a property owned by a user can be compared against market rent and prices and to make recommendations regarding rent capabilities. Property engine 118 can receive input such as local regulations, renter financial capabilities, and landlord financial goals. Property recommendations can be presented to an administrative user via the graphical user interface.

In some embodiments, the property management interface can incorporate AI engine 120. For example, the property management interface can display recommendations from AI engine 120 to a user (e.g., property owner or administrator) based on ML. Recommendations generated by AI engine 120 can be based on property data and tenant data, for example that was aggregated from multiple sources (e.g., databased 108, external applications, user input). Property and tenant data, which may be particularly relevant to AI engine 120 recommendations displayed via the property management interface, can include, for example, rent roll metrics (e.g., a snapshot of current income as represented by the owner of the asset), interaction metrics of users with property management platform 104, tenant spending and income data, and other sources of information (e.g., any data or metric mentioned in the present disclosure). In some implementations, AI engine 120 recommends cash rewards (e.g., cash back) to administrative users (e.g., landlords, property management companies) to enable them to improve the performance of their properties. Administrative users can select, through property management interface, specific goals for a property such as improving occupancy, increasing resident retention, reducing delinquency, attracting more qualified lease applicants, reducing incentive costs, and the like. AI engine 120 can be configured to analyze the property's existing performance as well as market performance and then recommend a cash back offer that the property should utilize to meet the goals of the manager or owner of the property.

In some implementations, messages generated by management platform 104 are sent based on determinations of AI engine 120. For example, notifications delivered by interface engine 114 can be based on ML. AI engine 120 can determine the best time to deliver a notification to a user as the time at which the notification is most likely to generate a productive outcome (e.g., engagement with management platform 104). In some example embodiments, access data of a particular user can be monitored. The access data is indicative of a day and/or a time when the user accessed one or more of interfaces provided by interface engine 114. AI engine 120 can identify trends indicative of days and/or times of day when the user is more likely to engage with (e.g., access) management platform 104. The computing device can then provide notifications to the particular user (e.g., via a GUI) during the identified periods of heightened activity. The notifications can include recommendations regarding real-estate investment and/or lifestyle changes.

In some embodiments, property management platform 104 allows for improved data consistency, quality, security, integration, scalability, and compliance, for example, through centralized data management among engines of property management platform 104. In example implementations, property management platform 104 can perform activities that could not feasibly be performed in the traditional siloed workflow solutions. For example, traditional siloed workflow solutions fail to provide dynamical digital engagements or interactions with renters and lack the ability to aggregate and interpret data.

In accordance with the present disclosure, embodiments are provided to improve data handling of renter data and property data, for example, to create pathways to enhance tenant retention. In some implementations, determining meaningful, but potentially hidden, associations and connections, between a renter and a desired outcome, such as identifying inducements to retain the tenant, can be accomplished by identifying multiple meaningful pathways connecting the entities. For example, associations can be dynamically mapped within a database (e.g., components library 106 and/or data store 108), such as a graph database and/or a relational database. In some implementations, a relative importance score of entities within the database (e.g., with regard to one another) can be determined. In further accordance with the disclosure, data retrieval techniques, as described elsewhere herein, can be combined to leverage management of property. For example, property data can be extracted from various connected devices and databases (e.g., the Internet of Things (IOT)) and used in combination with tenant data (e.g., social data) to derive reward workflows.

For purposes of illustration, and not limitation, in one embodiment of a system in accordance with the disclosure, reward engine 116 or an administrative user, such as a landlord or property manager, can utilize an embodiment of the disclosed system to interpret, and quantify, the relevance of a first element, such as a renter with respect to a second element, such as a vendor (e.g., restaurant or store) that is nearby to determine a relevance score of the renter with respect to the vendor. This process can be repeated for a plurality of renters with respect to a plurality of vendors to determine a relatively high relevance score, with the objective of identifying a vendor the renter frequents to provide the renter with a reward to the vendor as an inducement to make the tenant stay in the rental unit.

In an illustrative implementation incorporating user input, a property manager can input a name of the renter and a name of a vendor, into a property management interface of property management platform 104 provided in accordance with the disclosure. The names can be automatically associated with nodes N1, N2 in a database, such as a graph database, relational database, or other database structured to recognize relations between the renters and the vendors, for example by property engine 118. The property manager may then specify desired criteria C1, C2, C3 that could be used to link the renter to the vendor, such as whether the renter has been known to frequent the vendor (from back transaction data, for example), whether the renter's social media contacts frequent the vendor, whether the renter's phone geo-coordinates have overlapped with the location of the vendor, and the like. When actuated based on these inputs, property engine 118 determines the relevance of the renter with respect to the vendor based on the criteria. In examples, interface engine 114 can display a report interface element as part of a GUI that quantifies the relevance of the renter with respect to the vendor, evidencing direct, and more attenuated, or hidden, relevancies. For example, even though the renter's bank data may not evidence a transaction, the geolocation data of the renter and their friends may all coincide at the vendor at the same time, wherein it could be surmised that although the renter was present at a restaurant, they may have not paid the bill or paid in cash but may still favor the restaurant. Thus, property engine 118 can make determination based on cross-functional analytics and/or predictive modeling, allowing for incorporation of subtle connections (e.g., between a renter and a local vendor) into reward workflows. In examples, data architectures, such as a centralized data graph, can be more scalable and performant than decentralized or distributed data systems. Further, users (e.g., an administrative user in the previous example) can efficiently retrieve and update data mappings from a central location, reducing data duplication, redundancy, and the need for manual data transfers.

In operation, the information from the graph database can be directed to property engine 118 (e.g., which can be a server), which in turn generates a request for K (e.g., K=5) shortest paths between the document and the entity. This request is then directed to the graph database where the “K” shortest paths are generated in accordance with a shortest path algorithm. For example, Yen's method can be used (Yen, Jin Y. (1970). “An algorithm for finding shortest routes from all source nodes to a given destination in general networks”. Quarterly of Applied Mathematics. 27: 526-530), which is expressly incorporated by reference herein in its entirety for any purpose whatsoever. Yen's algorithm computes single-source K-shortest loopless paths for a graph with non-negative edge cost.

This can be accomplished by first computing “K” shortest paths by utilizing Equation 1 below:

$$\{ {d}_{i} = {\sum }_{pathi} ( 1 - w ) \} \qquad ( 1 )$$

The total distance can (e.g., then) be calculated by summing the inverses of each of the “K” shortest paths into the total distance by utilizing Equation 2 below:

$${d}_{total} = {( {\sum }_{i = 0}^{K} \frac{1}{{d}_{i}} )}^{- 1} \qquad ( 2 )$$

The total distance specified by Equation 2 can, if desired, be used to quantify the relevance of the story to the company. In example, an additional transform can optionally be performed, for example to improve clarity. The total distance can be transformed into a relevance score between 0 and 100 by using Equation 3 below:

$$Relevance = 100 {e}^{- K {d}_{total}} \qquad ( 3 )$$

By way of further example, Dijkstra's method for connecting two nodes with a shortest path can be used to calculate one or more of the shortest paths connecting nodes (Dijkstra, E. W. (1959). “A note on two problems in connection with graphs” (PDF). Numerische Mathematik. 1: 269-271), which is also expressly incorporated by reference herein in its entirety for any purpose whatsoever.

In this formulation, let the node at which we are starting be called the initial node. Let the distance of node Y be the distance from the initial node to Y. Dijkstra's algorithm will assign some initial distance values and will try to improve them step by step.

First, assign to every node a tentative distance value: set it to zero for the initial node and to infinity for all other nodes.

Second, set the initial node as current. Mark all other nodes unvisited. Create a set of all the unvisited nodes called the unvisited set.

Third, for the current node, consider all of its neighbors and calculate their tentative distances. Compare the newly calculated tentative distance to the current assigned value and assign the smaller one. For example, if the current node A is marked with a distance of 6, and the edge connecting it with a neighbor B has length 2, then the distance to B (through A) will be 6+2=8. If B was previously marked with a distance greater than 8 then change it to 8. Otherwise, keep the current value.

Fourth, when done considering the neighbors of the current node (e.g., all the neighbors), mark the current node as visited and remove it from the unvisited set. The visited node will not be checked again.

Fifth, if the destination node has been marked visited (when planning a route between two specific nodes) or if the smallest tentative distance among the nodes in the unvisited set is infinity (when planning a complete traversal; occurs when there is no connection between the initial node and remaining unvisited nodes), then stop. The algorithm has finished.

Sixth, otherwise, select the unvisited node that is marked with the smallest tentative distance, set it as the new “current node”, and go back to the third step.

In examples, after computing K shortest paths, property engine 118 can determine the shortest pathways and path lengths within the graph database. Property engine 118 can aggregate the K path lengths (e.g., via Equation 2 above), and the aggregate length can be transformed into a relevance score using Equation 3 above, for example. Property engine 118 can provision the relevance score to elements of system 100, such as reward engine 116 for consideration in generating a reward workflow.

In some implementations, dynamic data mappings implemented by property management platform 104 can allow for flexibility and automation in data integration and interoperability that are impossible or infeasible for a user to manually determine. For example, dynamic data mappings can involve high complexity rules, conditions, and transformations that are difficult to manage manually. As data volumes and complexity increase, the number of possible mappings and interactions between data elements grows exponentially, making it impractical for humans to determine all possible mappings accurately. Further, data mappings can accommodate variability in data formats, structures, and semantics across different systems, sources, and domains (e.g., heterogeneous data sources, formats, and domains, including structured, semi-structured, and unstructured data). Manually attempting to anticipate and account for all possible variations and edge cases can lead to human error-incomplete or inaccurate mappings. For example, in large-scale data integration scenarios involving thousands or millions of data elements, sources, and mappings, manual determination of dynamic data mappings quickly becomes impractical.

In some embodiments, data mappings can be used to facilitate data unification. Data unification is the process of consolidating data from various sources into a single, cohesive dataset. This process involves combining disparate data sets that may differ in format, structure, and origin to create a unified view that is consistent, accessible, and useful for analysis and decision-making.

In some implementations, property management platform 104 can perform data unification on tenant data, property data, and market data to convert data from different formats or structures into a common format or structure that can be easily analyzed. For example, data unification can include automated data matching (e.g., identifying and linking related records across different data sources) based on renter attributes and/or property attributes. For example data unification can include data deduplication (e.g., removal or combination of duplicate records to ensure that each piece of information is unique within the unified dataset). Unification of data by property management platform 104 can allow for enhanced decision-making and more comprehensive insights (e.g., by combining data from various sources).

The disclosed embodiments provide for feature(s) incorporating AI and machine learning (ML) in AI engine 120, for example to enhance and/or update data associations or mappings as previous described. Use of artificial intelligence, and more specifically ML (a subset of artificial intelligence), facilitates the customization and optimization of reward workflows by reward engine 116 and the provision of dynamic recommendations to users by interface engine 114. AI engine 120 interprets a mix of data points across tenant data and property data (e.g., financial, occupational, location, goals, current arrangement, and demographic trends) to predict a timing, a type, and/or a magnitude of a reward workflow (e.g., to prompt or encourage a tenant to take one or more actions), according to embodiments.

In some implementations, AI engine 120 can deploy AI and ML algorithms to address challenges that are unsuitable for being, or too costly to be, addressed using traditional property management techniques. Increasing data volumes, widening varieties of data (e.g., financial data, social data, market data) and more complex system requirements (e.g., interoperability), tend to require ML techniques. Accordingly, AI engine 120 is configured to produce models that can analyze larger, more complex data sets and deliver faster, more accurate results (e.g., without programmer intervention) as described herein.

Many different ML algorithms exist and, in general, a ML algorithm seeks to approximate an ideal target function, f, that best maps input variables x (the domain) to output variables y (the range), thus: y=f(x). The ML algorithm as an approximation of f is suitable for providing predictions of y.

Supervised ML algorithms generate a model for approximating f based on training data sets, each of which is associated with an output y. Supervised algorithms generate a model approximating f by a training process in which predictions can be formulated based on the output y associated with a training data set. The training process can iterate until the model achieves a desired level of accuracy on the training data. AI model 120 can implement and train supervised ML algorithms based on output from historical reward workflows and/or on synthesized output of desired tenant behavior (e.g., timely payment of rent) resulting from reward workflows.

Other ML algorithms do not require training. Unsupervised ML algorithms generate a model approximating f by deducing structures, relationships, themes and/or similarities present in input data. For example, rules can be extracted from the data, a mathematical process can be applied to systematically reduce redundancy, or data can be organized based on similarity. AI model 120 can implement unsupervised ML algorithms based on derived data mappings (e.g., by property engine 118). Over time, AI engine 120 can refine/update predefined data mappings based on output associated with implemented workflows (e.g., that can indicate the efficacy of a previously implemented workflow).

Semi-supervised algorithms can also be employed, such as a hybrid of supervised and unsupervised approaches.

Notably, the range, y, of f can be, inter alia: a set of classes of a classification scheme, whether formally enumerated, extensible or undefined, such that the domain x is classified e.g. for labeling, categorizing, etc.; a set of clusters of data, where clusters can be determined based on the domain x and/or features of an intermediate range y′; or a continuous variable such as a value, series of values or the like.

Clustering algorithms can be used, for example, to infer f to describe hidden structure from data including unlabeled data. Such algorithms include, inter alia: k-means; mixture models; neural networks; and hierarchical clustering. A clustering algorithm can be used by AI engine 120 to identify subtle connections (e.g., between a renter and a local vendor) into reward workflows. One illustrative implementation could be the previously described example involving a renter visiting a vendor but not paying. There, the connection between the renter and the vendor can be established without a visible connection present in financial data.

Classification algorithms address the challenge of identifying which of a set of classes or categories (range y) one or more observations (domain x) belong. Such algorithms are typically supervised or semi-supervised based on a training set of data. Algorithms can include, inter alia: linear classifiers such as Fisher's linear discriminant, logistic regression, Naïve Bayes classifier; support vector machines (SVMs) such as a least squares support vector machine; quadratic classifiers; kernel estimation; decision trees; neural networks; and learning vector quantization. As provided herein, classifications are applied by AI engine 120 to correlate data and make associations between tenants (e.g., tenant sets) and properties (e.g., similar properties based on, for example, market data), according to embodiments.

AI engine 120 can effectively address data privacy, model security, and compliance concerns that are raised for traditional solutions. For example, ML models often require access to sensitive or proprietary data for training, validation, and testing. In some illustrative examples provided herein, financial data can be used to establish reward workflows. AI engine 120 can incorporate ML algorithms tailored specifically for data mapping refinement can be implemented in a manner that tightly couples the ML algorithms to respective reward workflows. For example, Ai engine 120 can apply ML to data mappings between metrics rather than identifiable tenant data. For example, implementation of an ML algorithm for refinement of a reward workflow associated with cash rewards can beneficially address challenges of traditional solutions, such as privacy, by implementing anonymization techniques throughout the ML lifecycle (e.g., as described herein). Associations between income and likelihood of rent payment, for example, can be analyzed without regard to personally identifying information.

In some implementations, AI engine 120 interpretability and transparency with other elements of system 100, including reward engine 116 and component library 106, can facilitate auditing, debugging, and validating ML applications, particularly in safety-critical areas such as finance. For example, an administrative user customizing a reward workflow through reward engine 116 can apply a reward workflow to a particular tenant without being granted access to the financial data of the tenant. Reward engine 116 can then adjust and customize the applied reward workflow automatically, in real time, for example, based on tenant data associated with the tenant without the administrative user being aware of the underlying data. In some instances, implementation of reward workflows to tenants or tenant sets can be blind, meaning administrative users are isolated from all tenant-specific information. Data blindness can refer to administrative users relying solely on data-driven insights without considering other factors. In some implementations of property management platform 104, data blindness can reduce concerns over improper allocation of reward workflows, such as bias, while AI engine 120 can make informed determinations based on sensitive data (e.g., only where necessary). Qualitative assessments can then be made on the results of AI engine to facilitate development/refinement of ML applications. The ability to integrate AI engine 120 within property management platform 104 in this way provides the opportunity for discrete machine learning algorithms to mitigate security risks.

In some example embodiments, inputs from renters and/or members can be used for machine learning. For instance, data collection and predictive analytics may be used to determine when tenants want to stay in a unit (and therefore renew a lease), when tenants want to move (and therefore not renew a lease), and/or if moving, whether the tenant desires a larger or smaller unit, which neighborhood, etc. Further, data collection and predictive analytics may be used to determine which facilities tenants are using or not using (such as amenities offered by the residence), the delinquency rate for a typical renter, group of renters, or a particular renter, and the likelihood of a renewal of a lease. For instance, machine learning may be used to provide recommendations on housing unit pricing, ownership offers, and/or marketing options for renters to provide renters with incentives to renew their leases. Such machine learning processes may receive as input, data pertaining to location, facility usage, overall engagement, web browser activity, and historical performance of other comparable rewards, among other data.

An (e.g., each) application interface may engage a user to collect data while artificial intelligence and/or machine learning algorithms (e.g., as implemented by AI engine 120) generate content to be displayed on the (e.g., each) respective interface. For example, the disclosed embodiments can be enhanced by reinforcement learning, natural language processing, and recommendation functionality. AI engine 120 can, for example, determine where a tenant might want to live considering a variety of data points (e.g., both internal and external) and can match tenants with housing unit inventory across property owners.

For example, in some implementations, utilizing statistics and ML, implementations of AI engine 120 can utilize time series forecasting (“TSF”) to model behaviors of a renter and forecast future behavior. TSF can use historical and current data to predict future values over a period of time or a specific point in the future. For example, TSF can be used to model a renter's propensity to execute one or more behaviors, such as paying rent on time, based on tenant data indicating previous behaviors and/or attributes of the renter.

In implementations, AI engine 120 can implement TSF across data sources and types (e.g., tenant data, property data) to make predictions based on cross-domain input. For example, predictions of AI engine 120 can be based on tenant data, such as financial data (e.g., past rent payments, the payment of other bills on time, employment status, income, and overall financial condition). For example, predictions of AI engine 120 can be based on external factors, such as economic indicators (e.g., stock market performance, inflation rate, and employment rate), particularly when considered in combination with tenant attributes and social factors (e.g., education level, work history, time at a present job, time spent at preceding jobs, and the like). AI engine 120 can aggregate renter financial behavior to derive trends. In examples, AI engine 120 can determine an applicability of derived trends to particular renters and/or derive renter-specific trends. In implementation a derived renter trend can be whether a variable in a time series will increase or decrease the likelihood that the renter will pay rent in a (e.g., each) period.

Based on a desired outcome, AI engine 120 can weight external data relative to tenant data and/or property data associated with a particular tenant. For example, the weighting of data can be based on the probability of a trend applying to a renter. In such an example, the probability of the trend applying to the renter can be determined based on a similarity threshold between the renter and other renters from which the trend was derived. The similarity threshold can be based on, for example, similarity between tenant attributes of tenant profiles. For example, if a subset of tenant attributes associated with financial data are the same or categorically identified as similar between tenant profiles, AI engine 120 can group the tenant profiles as a tenant set. Tenant sets can be used, for example by AI engine 120, to apply derived trends. Criteria/conditions (e.g., such as similarity thresholds) used to determine tenant sets can be dynamically updated (e.g., iteratively improved) over time using ML. ML can be applied to output of previously applied trends to determine if the trend successfully forecasted behavior across the tenant set to which it was applied.

When applying AI, unexpected events (sometimes also referred to as noise or irregularities) can always occur, and it is possible to consider this data when creating a prediction model. Such events present “noise” in historical data and are themselves not predictable. As such, predicting a particular unexpected event is by its nature unlikely, but noting the presence of unexpected events in historical data can be used by AI engine 120 to provide a weighting factor in a predictive model.

In some embodiments, seasonality, such as time patterns of a propensity of a renter to pay, can be considered to help estimate whether a rent payment is more or less likely to be made in a given timeframe (e.g., month of the year). For example, tenant data can indicate that a renter is a seasonal worker for a ski resort. The renter can have a greater propensity to save and pay rent during the winter months when elevated compensation may be available. Based on this information, AI engine 120 can account for seasonality in the behavior of the renter. In some implementations, such an example can be leveraged by reward engine 116 to implement a customized and/or optimized reward workflow that encourages the renter to increase saving during the winter months. These insights can be expanded as appropriate. For example, if a property is situation near a ski resort, a reward workflow that accounts for seasonality can be implemented for the property or a tenant set associated with the property.

One or more forecasting methods can be used in TSF, such as time-series decomposition, time-series regression models, exponential smoothing, ARIMA models, neural networks and TBATS.

Time-series decomposition is a method for explicitly modeling data as a combination of seasonal, trend, cycle, and remainder components instead of modeling it with temporal dependencies and autocorrelations. AI engine 120 can perform time-series decomposition as a standalone method for TSF or as the first operation in better understanding data. When using a decomposition model, AI engine 120 can forecast future values for each of the aforementioned components and then add these predictions together to find the most accurate overall forecast. Some of the most relevant forecasting techniques using decomposition are Seasonal-Trend decomposition using LOESS, Bayesian structural time-series (BSTS), and Prophet. Time-series decomposition refers to a technique that decomposes time-series data into the following components: trend, cycle, seasonality, and remainder.

Decomposition based on rates of change can be used by AI engine 120 for analyzing seasonal adjustments. The technique constructs several component series, which, when combined (using additions and multiplications), result in the original time series. Each of the components has a certain characteristic or type of behavior, and they usually include a trend component, a cyclical component, a seasonal component and an irregular component. The trend component at time t describes the long-term progression of the time series. A trend is present when there is a consistent increase or decrease in the direction of the data. The trend component is not constrained to a linear function. The cyclical component at time t reflects repeated but non-periodic fluctuations. The duration of these fluctuations depends on the nature of the time series. The seasonal component at time, t, reflects seasonality (seasonal variation). Such a seasonal pattern can be found in time series that are influenced by seasonal factors. Seasonality usually occurs in a fixed and known period (for example, holiday seasons). The irregular component (or “noise”) at time, t, represents random and irregular influences. It can also be considered the remainder of the time series after other components have been removed.

Additive decomposition implies that time-series data is a function of the sum of its components. Alternatively, instead of using addition to combine the components, multiplicative decomposition defines time-series data as a function of the product of its components. Identifying a time series as additive or multiplicative depends on its variation. If the magnitude of the seasonal component is dynamic and changes over time, it's safe to assume that the series is multiplicative. If the seasonal component is constant, the series is additive.

Time-series regression can be used by AI engine 120 to forecast future values based on historical data. The forecast variable is also called the regress and, dependent or explained variable. The predictor variables are sometimes called the regressors, independent or explanatory variables. Regression algorithms attempt to calculate the line of best fit for a given dataset. For example, a linear regression algorithm can be used in an effort to minimize the sum of the squares of the differences between the observed value and predicted value to find the best fit. Alternatively, a non-linear regression technique can be used (e.g. polynomial regression) to better fit the data where appropriate.

When it comes to time-series forecasting, data smoothing can improve the accuracy of predictions by removing outliers from a time-series dataset. This leads to increased visibility of distinct and repeating patterns that would otherwise be hidden between the noise. Exponential smoothing is a rule-of-thumb technique for smoothing time-series data using the exponential window function. Whereas the simple moving average method weighs historical data equally to make predictions about the future, exponential smoothing uses exponential functions to calculate decreasing weights over time. Different types of exponential smoothing include simple exponential smoothing and triple exponential smoothing (also known as the Holt-Winters method). Some methods combine the trend and cycle components into one trend-cycle component. It can be referred to as the trend component even when it contains visible cycle properties. For example, when using seasonal-trend decomposition with LOESS, the time series is decomposed into seasonal, trend, and irregular (also called noise) components, where the cycle component is included in the trend component.

In some implementations, AI engine 120 can use AutoRegressive Integrated Moving Average (ARIMA). ARIMA is a forecasting method that combines both an autoregressive model and a moving average model. Autoregression uses observations from previous time steps to predict future values using a regression equation. An autoregressive model utilizes a linear combination of past variable values to make forecasts.

Neural networks can be used to approximate a continuous function sufficiently well for time-series forecasting. While classical methods like ARMA and ARIMA assume a linear relationship between inputs and outputs, neural networks are not bound by this constraint. They are able to approximate any nonlinear function without prior knowledge about the properties of the data series. Neural networks such as multilayer perceptrons (MLPs) offer advantages. For example, neural networks are not only robust to noise when it comes to input data but also robust in the mapping function. This can be useful when working with data that contains missing values. Neural networks are not bound to strong assumptions and a rigid mapping function. They are able to learn from new linear and nonlinear relationships continuously. Multivariate forecasting is supported by neural networks because the number of input features is completely variable. As multi-step forecasts: The number of output values is variable as well.

By way of further example, a TBATS model can deal with complex seasonality (e.g., non-integer seasonality, non-nested seasonality, and large-period seasonality) with no seasonality constraints, making it possible to create detailed, long-term forecasts. TBATS is an acronym for some of the most important features that the model offers, including T: Trigonometric seasonality, B: Box-Cox transformation, A: ARIMA errors, T: Trend, and S: Seasonal components.

In further accordance with the disclosure, reinforcement learning (RL) can be used by AI engine 120 to make recommendations for taking action in real estate management. For example, RL can be used for strategy exploration as an agent optimizing for the right balance between, for example, concessions to be made to new or existing tenants and acceptable occupancy and delinquency rates over time and across all properties.

In further accordance with the disclosure, anomaly detection algorithms can also be employed by AI engine 120. Anomaly detection can be used to monitor if systems are behaving out of the ordinary and can similarly be used to estimate the propensity of a renter to pay rent or engage in other requested activities, such as performing repairs if requested, and the like.

In accordance with the present disclosure, AI as implemented through AI engine 120, can be used to provide recommendations on the magnitude, timing, and type of tenant reward based on user indicated renter goals and collected data points.

In some implementations, based on one or more determinations, AI engine 120 takes automatic action, for example, through programmatic process automation. For instance, AI engine 120 can include, discrete sub-engines. In examples, AI engine 120 includes a pricing sub-engine, a matching sub-engine, and recommendation sub-engine. A (e.g., each) sub-engine may run on the property management platform and be communicatively connected to particular interfaces. For example, sub-engines can be connected to necessary third parties, such as payment gateways, brokerage accounts, property management systems, blockchain networks, distributed ledgers, and wallets, among others. The pricing sub-engine may include an algorithm (e.g., non-transitory machine readable instructions executable by a processing resource) for analyzing internal and/or external data to provide retail and wholesale pricing guidance. The matching sub-engine may include an algorithm for analyzing tenant-specific data (e.g., interface engagement, unit preferences, investment profile, rental application, location, etc.) to match renters with available units. The recommendation sub-engine may include an algorithm for analyzing internal and/or external data (e.g., matching data, actions of other similar profiles and personas, geolocation data, demographics, demand, supply) to provide housing and personal finance recommendations and marketing offers (e.g., neighborhood, unit type, lease extension, furniture, vacations, moving, pet care, etc.).

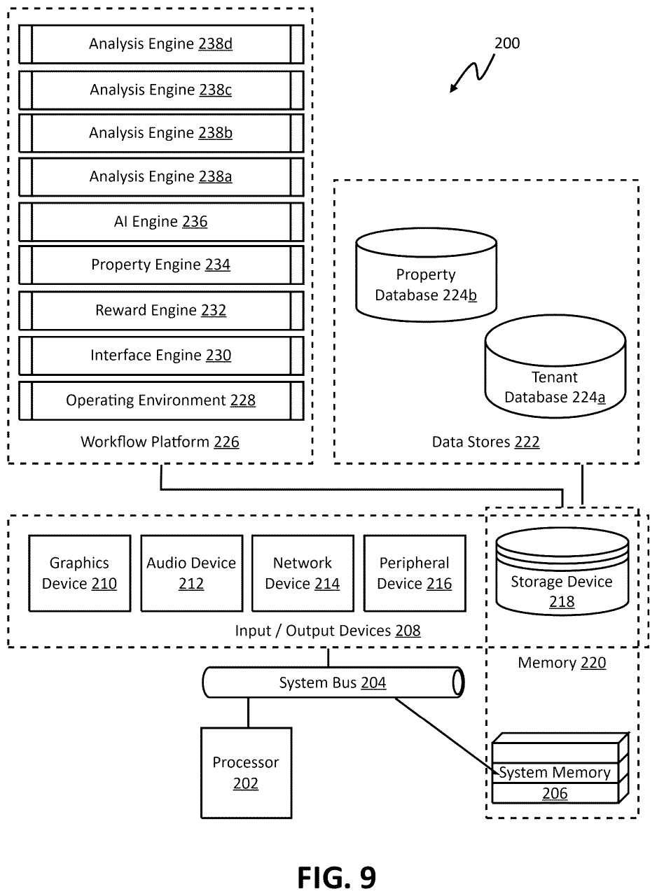

Referring to FIG. 9, a block diagram of system 200 for managing properties and tenants is depicted, according to an embodiment. In some embodiments, system 200 includes many of the same components as system 100, but which are renumbered in FIG. 9 for ease of discussion. System 200 generally includes a processor 202, a system bus 204, a system memory 206, input/output device(s) 208, data store(s) 222, and a workflow platform 226. In some implementations, system 200 can be a server or network-enabled computing device. In some embodiments, system 200 facilitates the feature(s) and functionality described herein with respect to operation of system 100.

The disclosed embodiments can leverage the advantages of cloud storage and cloud computing. Infrastructure as Code (IaC) may be leveraged to manage and provision infrastructure through code instead of through manual processes. With IaC, configuration files can be created that contain infrastructure specifications, which can allow for easier editing and distribution of configurations.

System 200 includes processor 202 that executes program instructions. Processor 202 may be connected to system memory 206 via system bus 204. System bus 204 may interconnect these and/or other elements of the coordinator via electrical, electronic, optical, wireless, and/or the like communication links (e.g., system bus 204 may be integrated into a motherboard that interconnects coordinator elements and provides power from a power supply). In various embodiments, system memory 206 may be discreet, external, embedded, integrated into a CPU, and/or the like. Processor 202 may access, read from, write to, store in, erase, modify, and/or the like, system memory 206 in accordance with program instructions executed by the processor. System memory 206 may facilitate accessing, storing, retrieving, modifying, deleting, and/or the like data by processor 202.

In various embodiments, input/output devices 208 may be connected to processor 202 and/or to system memory 206, and/or to one another via system bus 204. In some embodiments, input/output devices 208 may include, for example, one or more: graphics devices 210, audio devices 212, network device 214, peripheral devices 216, or storage devices 218. Input/output devices 208 may operate in combination (e.g., in parallel) with other input/output devices 208 to provide improved capabilities, data throughput, and/or the like. For example, a first audio device 212 may operate in combination with a second audio device 212. Processor 202 may make use of one or more input/output devices 208 in accordance with program instructions executed by processor 202.

In some embodiments, input/output devices 208 include graphics device 210. Graphics device 210 may be a video card that may obtain (e.g., via a connected video camera), process (e.g., render a frame), output (e.g., via a connected monitor, television, and/or the like), and/or the like graphical (e.g., multimedia, video, image, text) data.

In some embodiments, input/output devices 208 include audio device 212. Audio device 212 may be a sound card that may obtain (e.g., via a connected microphone), process, output (e.g., via connected speakers), and/or the like audio data.

In some embodiments, input/output devices 208 include network device 214. Network device 214 may be a network card that may obtain (e.g., via a Category 5 Ethernet cable), process, output (e.g., via a wireless antenna), and/or the like network data. Network device 214 may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, input/output devices 208 include peripheral device 216. Peripheral device may be a camera, a display, a wearable device, a control mechanism (e.g., a keyboard), or the like.

In one aspect, workflow platform 226 can be provided to provide Wi-Fi mesh network at all rental sites, for example, though peripheral devices 216. The Wi-Fi mesh network can act as a potential revenue generation tool by selling the service to renters and non-renters alike.

In some embodiments, input/output devices 208 include storage device 218. Storage device 218 may facilitate accessing, storing, retrieving, modifying, deleting, and/or the like data (e.g., graph database data as described elsewhere herein) by processor 202. In one implementation, processor 202 may access data from storage device 218 directly via system bus 204. In another implementation, processor 202 may access data from storage device 218 by instructing the storage device 218 to transfer the data to system memory 206 and accessing the data from system memory 206. Storage device 218 may be discreet, external, embedded, integrated (e.g., into a motherboard, into another storage device), and/or the like. Storage device 218 may operate in combination with other storage devices to provide improved capacity, data throughput, data redundancy, and/or the like.

Together and/or separately system memory 206 and one or more storage devices 218 can be referred to as memory 220 (e.g., physical memory). Memory 220 contains processor-operable (e.g., accessible) data stores 222. Data stores 222 include data that may be used via system 200. Such data may be organized using one or more data formats such as one or more of a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores 222 may be organized in any number of ways (e.g., using any number and configuration of data formats, data structures, coordinator elements, and/or the like) to facilitate operation. For example, data stores 222 can comprise data stores 224a-n implemented as one or more (e.g., graph) databases. In some implementations, data stores 222 includes tenant database 224a and property database 224b. Tenant database 224a and/or property database 224b can be data stores that are a collection of database tables including fields. For example, fields of tenant database 224a can include TenantID, TenantName, TenantPreferences, and/or the like. For example, tenant database 224a can store tenant profiles and/or tenant attributes. For example, property database can store property data, such as market data. Data stores 222 can be a collection of graph databases.

Memory 420 can contain processor-operable (e.g., executable) instructions and components. Components comprise program components (including program instructions and any associated data stores) that are executed via system 200 (i.e., via processor 202) to transform inputs into outputs. In some embodiments, components include workflow platform 226. It is to be understood that the various components and their subcomponents, capabilities, applications, and/or the like may be organized in any number of ways (i.e., using any number and configuration of components, subcomponents, capabilities, applications, coordinator elements, and/or the like) to facilitate operation. Furthermore, it is to be understood that the various components and their subcomponents, capabilities, applications, and/or the like may communicate among each other in any number of ways to facilitate operation. For example, the various components and their subcomponents, capabilities, applications, and/or the like may be combined, integrated, consolidated, split up, distributed, and/or the like in any number of ways to facilitate operation. In another example, a single or multiple instances of the various components and their subcomponents, capabilities, applications, and/or the like may be instantiated on each of a single coordinator node, across multiple coordinator nodes, and/or the like.

In some embodiments, workflow platform 226 can include an operating environment 228. Operating environment 228 facilitates operation of system 200 via various subcomponents. In some implementations, operating environment 228 may include an operating system subcomponent. Operating environment 228 may provide an abstraction layer that facilitates the use of, communication among, common services for, interaction with, security of, and/or the like of various coordinator elements, components, data stores, and/or the like.

In some embodiments, operating environment 228 may facilitate execution of program instructions by processor 202 by providing process management capabilities. For example, operating environment 228 may facilitate the use of multiple processors, the execution of multiple processes, multitasking, and/or the like.

In some embodiments, operating environment 228 may facilitate the use of memory 220 by system 200. For example, operating environment 228 may allocate and/or free memory, facilitate memory addressing, provide memory segmentation and/or protection, provide virtual memory capability, facilitate caching, and/or the like. In another example, operating environment 228 may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, operating environment 228 may facilitate operation of and/or processing of data for and/or from input/output devices 208. For example, operating environment 228 may include one or more device drivers, interrupt handlers, file systems, and/or the like that allow interaction with input/output devices.

In some embodiments, operating environment 228 may facilitate operation of the system 200 as a node in a computer network by providing support for one or more communications protocols. For example, operating environment 228 may include support for the internet protocol suite (i.e., Transmission Control Protocol/Internet Protocol (TCP/IP)) of network protocols such as TCP, IP, User Datagram Protocol (UDP), Mobile IP, and/or the like). In another example, operating environment 228 may include support for security protocols (e.g., Wired Equivalent Privacy (WEP), Wi-Fi Protected Access (WPA), WPA2) for wireless computer networks. In yet another example, operating environment 228 may include support for virtual private networks (VPNs).

In some embodiments, operating environment 228 may facilitate security of system 200. For example, operating environment 228 may provide services such as authentication, authorization, audit, network intrusion-detection capabilities, firewall capabilities, antivirus capabilities, and/or the like.

In some implementations, operating environment 228 may include a security subcomponent that facilitates system security. In some embodiments, the security subcomponent may restrict access to system 200, to one or more services provided by system 200, to data associated with system 200 (e.g., stored in data stores 222), to communication messages associated with system 200, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the system may include symmetric key cryptography using shared keys (e.g., using one or more block ciphers), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like.

In some implementations, operating environment 228 may include a virtualization subcomponent that facilitates virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted. In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like.

In embodiments, workflow platform 226 can include various engines, including an interface engine 230, reward engine 232, property engine 234, AI engine 236, and analysis engines 238a-238d. In some embodiments, various engines are configured to provide the functionality as described with respect to system 100.

In some embodiments, workflow platform 226 can include interface engine 230 to facilitate user interaction with the system by providing interface elements that may be used by the system to generate a resident interface and/or a property management interface. In one implementation, such interface elements include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. In another implementation, such interface elements include sounds (e.g., event notification sounds stored in MP3 file format), animations, vibrations, and/or the like that may be used to inform the user regarding occurrence of various events. In various implementations, interface engine 230 includes instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like.

In some implementations, interface engine 230 includes an information handling subcomponent. The information handling subcomponent may provide the system with capabilities to serve, deliver, upload, obtain, present, download, and/or the like a variety of information.

In some embodiments, the information handling subcomponent may facilitate the serving of information to users, system components, nodes in a computer network, web browsers, and/or the like. For example, the information handling subcomponent may comprise a web server. For example, the information handling subcomponent may use such standards to store, analyze, retrieve, access, modify, delete, aggregate, generate, and/or the like data (e.g., data from data stores 222).

In some embodiments, the information handling subcomponent may facilitate presentation of information obtained from users, system components, nodes in a computer network, web servers, and/or the like. For example, the information handling subcomponent may comprise a web browser. Furthermore, a web browser may include extensions, plug-ins, add-ons, applets, and/or the like.

In some implementations, interface engine 230 includes a messaging subcomponent. The messaging subcomponent may facilitate system message communications capabilities. The messaging subcomponent may use protocols such as APIs, custom protocols, and/or the like to facilitate system message communications.

In embodiments, a blockchain can be used in conjunction with a property management platform (e.g., as described herein). A blockchain is a distributed chain of block data structures accessed by a network of nodes, referred to as a miner network. Each block in the blockchain includes a plurality of record data structures known as transactions, with a (e.g., each) transaction referring to or relating to a prior transaction. For example, in an embodiment each blockchain includes a Merkle of hash or digest values for transactions included in the block to arrive at a hash value for the block, which is itself combined with a hash value for a preceding block to generate a chain of blocks (e.g., the blockchain).

A new block of transactions is added to the blockchain by miner software, hardware, firmware or combination systems in a miner network. The miners are communicatively connected to sources of transactions and access or copy the blockchain. A miner undertakes validation of the substantive content of a transaction and adds a block of new transactions to the blockchain when a challenge is satisfied as a proof of work. Generally, challenges involve a combination hash or digest for a prospective new block and a preceding block in the blockchain and some challenge criterion. Thus, miners in the miner network may each generate prospective new blocks for addition to the blockchain. Where a miner satisfies or solves the challenge and validates the transactions in a prospective new block such new block is added to the blockchain. Accordingly, the blockchain provides a distributed mechanism for reliably verifying a data entity. Transactions added erroneously or maliciously are not verifiable by other miners in the network and their persistence in the blockchain is undermined.

In some implementations, a property management platform can incorporate blockchain-based identity management solutions to enhance tenant screening and identity verification processes. For example, property management platform can securely store and share tenant identity information, background checks, and rental history data on a blockchain. Such use of a blockchain allows for decentralized identity verification, reducing the risk of identity theft, fraud, or data breaches that may be associated with centralized identity repositories.

Blockchain can be used as described elsewhere herein. But, furthermore, a decentralized autonomous organization (DAO) can be used. A DAO is an emerging form of legal structure that has no central governing body and whose members share a common goal to act in the best interest of the entity. Non-fungible tokens (NFTs), are blockchain-based tokens that each represent a unique asset like a piece of art, digital content, or media. An NFT can be thought of as an irrevocable digital certificate of ownership and authenticity for a given asset, whether digital or physical. Such tokens can be used in accordance with property ownership, leasing and management as real estate deeds or leases, such as ground leases. Blockchain-based alternatives to traditional financial services have come to be called decentralized finance, or DeFi. Such financial services can be used in the financial management of real estate holdings such as the operation of apartment buildings and the like, as disclosed herein. A Blockchain Validator performs validation by verifying that transactions are legal, and can be used in the ownership transfer of real estate as well as in the leasing and subleasing of real estate in accordance with the disclosed embodiments.

Blockchain decentralized applications (dApps) are digital applications that run on a blockchain network of computers instead of relying on a single computer. Because dApps are decentralized, they are free from the control and interference of a single authority. Such approaches can be used to implement the disclosed embodiments of real estate management. Blockchain autonomous economic agents (AEAs) act independently of constant input from their owner and autonomously execute actions to achieve a prescribed goal—for example, to create economic value their owner, in a clearly defined domain. Such agents can be used to optimize any of the system objectives set forth herein.

Quantum information science is an interdisciplinary field that seeks to understand the analysis, processing, and transmission of information using quantum mechanics principles. Quantum computing can be used to help understand complex relationships between renter behavior and economic conditions as described above.

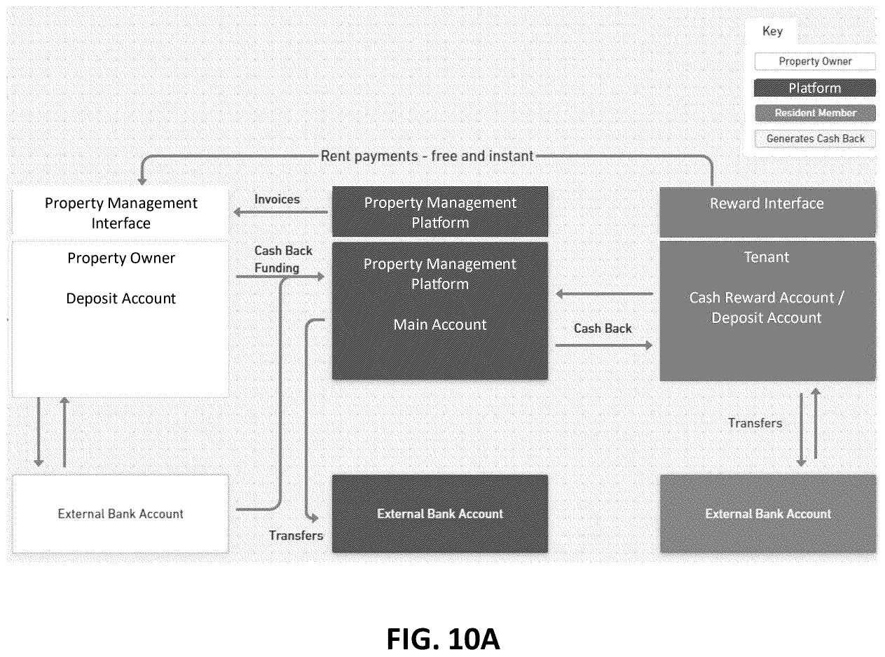

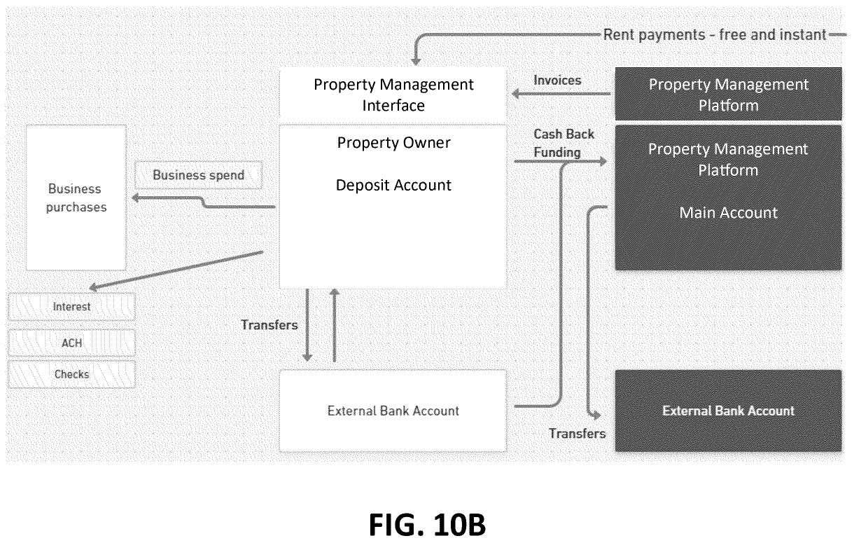

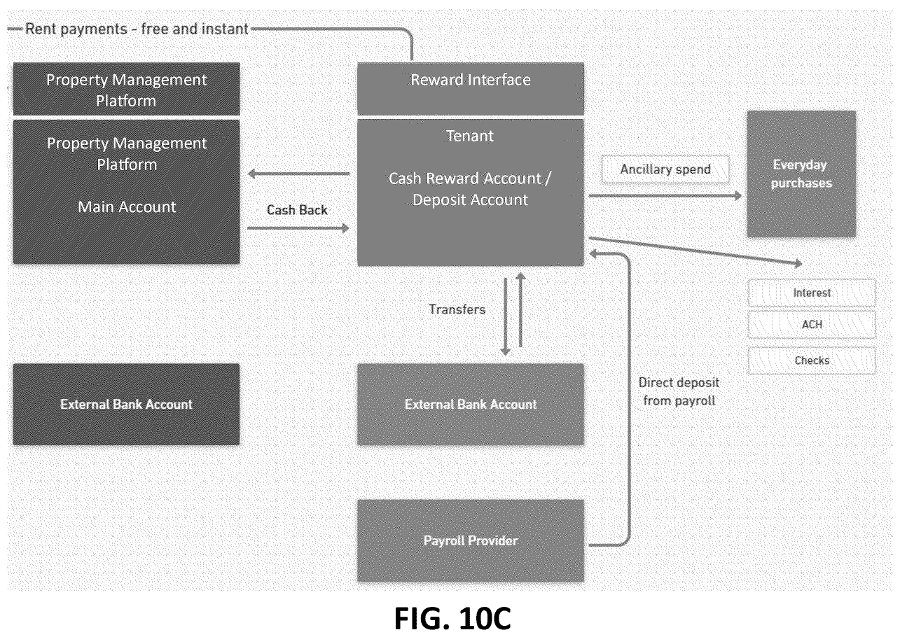

Referring to FIGS. 10A-C, a process flow diagram of an example method for managing finances through a property management platform is depicted, according to an embodiment. In some embodiments, the method can be implemented by system 100 and/or system 200 as depicted in FIGS. 1 and 9 respectively.

Referring to FIG. 10A, the property management platform issues invoices to the property owner to pay for cash back rewards that the property management platform pays to tenants, and for other services. The property management platform main account receives payments for funding the cash rewards and issues the cash back rewards to the tenant. As illustrated, the tenant pays the property owner rent payments directly. In some implementations, the tenant does not pay the property owner rent payments directly (not shown). The tenant can use an external bank account outside of the property management platform that can be linked to the property management platform (e.g., as shown) and/or the property owner account (not shown). Not pictured in FIGS. 10A-10C are pathways between the property management platform and third-party payment providers such as banks. Financial transaction information can be routed from banks, payment services, and the like to property management platform to populate a database with metrics to analyze renter behaviors. Such data can (e.g., also) be routed from a user's mobile device if the user authorizes this activity.

Referring to FIG. 10B, additional example connections of the property owner's deposit account are depicted, for example, which can earn the property owner cash rewards. Referring to FIG. 10C, additional example connections of the tenant's deposit account are depicted, for example, which can earn the tenant cash rewards. Cash rewards, such as the cash back for the illustrative examples depicted in FIGS. 10B-10C can be associated with reward workflows generated in the property management platform.

In embodiments, the property owner's deposit account and the tenant's deposit account can be each be associated with respective virtual debit card(s) and physical debit card(s). In some implementations, the property owner's deposit account and the tenant's deposit account can be each be associated with respective special purpose property management platform debit card(s), for example for use with the system depicted in FIGS. 10A-10C.

In accordance with a further implementation, the payment network can be configured to permit an authenticated tenant (e.g., a “user”) to pay rent via ACH, such as with the checking account associated with the user's property management platform debit card and earn cash rewards for doing so. Accordingly, the user can use the ACH payment method to pay rent via the checking account associated with their property management platform debit card and to earn cash rewards on rent when doing so.

Cash rewards and, for example, point-based loyalty programs are distinct in several ways, including structure, redemption options, and perceived value. Cash rewards typically offer monetary incentives directly to consumers, such as cashback on purchases or cash bonuses for specific actions or behaviors. Cash rewards are straightforward and universally appealing due to their tangible monetary value. Point-based loyalty programs award points or credits to consumers based on their spending or engagement activities. These points can be redeemed for rewards, such as discounts, free products, or exclusive perks, based on a predetermined redemption schedule.

Embodiments of the property management platform according to the present disclosure can facilitate various reward types including cash rewards and/or point rewards (e.g., for use in redeeming various rewards for an associated number of points). Notably, cash rewards can provide flexibility in redemption options, as consumers can use cash incentives for any purpose, such as paying bills-including rent, making purchases, or saving for future expenses. Cash rewards offer immediate and tangible benefits without restrictions on how the funds are spent, providing simplicity and clarity in terms of the value proposition and redemption. In contrast, point-based loyalty programs often offer a selection of rewards or incentives that consumers can redeem using accumulated points. In such programs, redemption options are limited to specific products, services, or experiences offered by participating merchants or partners.

Implementation of cash reward workflows in a property management platform can require balancing financial considerations, such as cost management, regulatory compliance, and risk of fraud. Offering cash rewards entails allocating financial resources to fund the rewards program. Property management companies may need to budget for cash incentives, set aside funds for redemption, and manage cash flow to ensure sustainability and profitability of the rewards program.

In one aspect, cash rewards workflows can incur direct costs associated with disbursing cash incentives, such as transaction fees, administrative expenses, and fulfillment costs. The property management platform can clearly identify costs to avoid property management overspending while offering attractive rewards to tenants. For example, the property management platform can provide recommendations to property management regarding cost insights, such as tailoring the magnitude of cash rewards based on tenant behavior. In such an example, the property management platform can provide a recommendation on a magnitude of cash reward that is likely to induce participation from tenants without overspending (e.g., as described through various implementation techniques described herein).

In a second aspect, cash rewards workflows are subject to regulatory requirements, including consumer protection laws, tax regulations, and anti-money laundering (AML) policies. The property management platform can ensure generated workflows comply with applicable laws and regulations governing cash incentives, financial transactions, and customer data privacy.

In a third aspect, cash rewards workflows may be vulnerable to fraud, abuse, and exploitation by dishonest participants seeking to exploit loopholes or manipulate the system for personal gain. The property management platform can implement robust fraud detection, prevention, and mitigation measures to safeguard against fraudulent activities and maintain program integrity. For example, the property management platform can implement a proof-of-task system that requires tenants to submit a photograph evidencing the completion of a reward workflow task. Such a proof-of-task system can provide additional context, for example via metadata, that can allow for more robust verification methodologies.

Embodiments of the property management platform of the present disclosure allow for implementing cash rewards programs while reducing operational complexities that are prevalent in traditional solutions (e.g., such as an inability to track reward eligibility, customize incentive amounts, and internally process payments and reconcile transactions). Property management platforms as described herein provide feature(s) to dynamically generate and recommend compelling rewards structures, communicate program benefits clearly, and create incentives that resonate with tenants' needs, preferences, and motivations to drive participation and engagement.

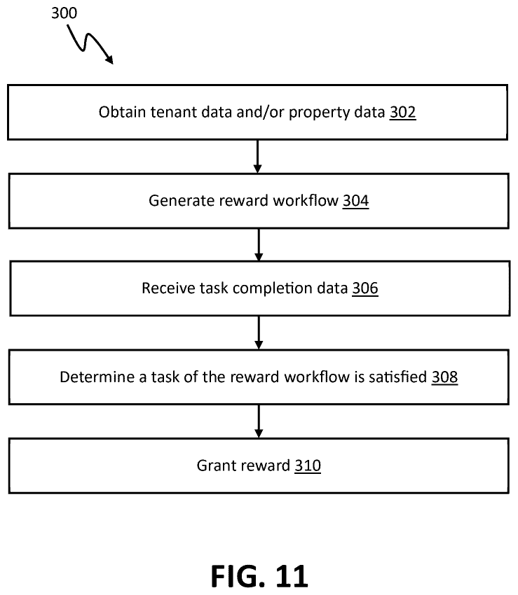

Referring to FIG. 11, a flowchart of a method 300 of generating a reward workflow based on tenant data is depicted, according to an embodiment. In some embodiments, method 300 can be implemented by system 100, 200, and/or 300 as depicted in FIGS. 1-3. Reference will be made to system 100 for ease of discussion.

At 302, method 300 comprises obtaining tenant and/or property data. In embodiments, property management platform 104 obtains tenant data and property data, for example, using one or more of: user input (via interface engine 114); interaction analytics (e.g., user interactions when using property management platform 104); tracking technologies, such as cookies; APIs and integrations with external platforms and/or data providers (e.g., data store 108); or scraping and web crawling techniques.

In some implementations, tenant data includes information related to individuals or entities renting or leasing properties. Tenant data can include, for example, one or more of: financial data, social data, geographic data, and tenant goals. Tenant data can be associated with a particular tenant and/or a tenant set.

In some implementations, property data includes information related to properties and property markets. Property data can include, for example, market data and attributes of owned properties. Property data can be associated with a particular administrative user (e.g., a property owner or manager).

At 304, method 300 comprises generating a reward workflow (e.g., by reward engine 116). For example, a reward workflow can associate one or more inputs, such as tasks to be completed by a tenant, with output, such as a cash reward. The reward workflow can define one or more conditions for receiving the output, such that the input is verifiable. In some implementations, property engine 118 can be used to detect the satisfaction of the one or more conditions.

In some embodiments, reward workflows can be generated by reward engine 116 based on user input received via a GUI of interface engine 114 (e.g., a property management interface). The GUI can include graphical or text-based interfaces for defining and designing reward workflows. For example, a user can define reward workflow components and declare their attributes.

In some embodiments, reward engine 116 supports reward workflow management and execution. For example, reward engine 116 is configured to declare inputs and associated attributes. For example, reward engine 116 can define a custom reward workflow to automate a loyalty program according to defined conditions. Components of a reward workflow can be manipulated by a user, for example a user of computing device 102, to efficiently adjust values of and/or associations between inputs (e.g., tenant actions) and outputs (e.g., a cash reward).

At 306, method 300 comprises receiving task completion data. Task completion data can include tenant data and/or property data (e.g., as described herein) that is indicative or otherwise associated with a task of a reward workflow. For example, task completion data can comprise user input to a resident interface provided by interface engine 114. For example, task completion data can comprise tenant data scrapped by property engine 118 from a social media platform. For example, task completion data can comprise property data received from a data store indicative of a rental unit becoming occupied.

At 308, method 300 comprises determining the task associated with the reward workflow is complete. In embodiments, at 308 task completion data can be compared to a condition of the reward workflow to determine whether the condition is satisfied. If the condition is not satisfied, a notification can be provided via resident interface indicating the condition is not satisfied. In some implementations, instructions associated with the task and/or reward workflow can be provided via the resident interface.

At 310, method 300 comprises granting a reward associated with the completed task. The reward workflow can specify scalable rewards based on the satisfaction of the associated task (e.g., as described herein).

Method 300 accordingly provides for dynamically generating and implementing a reward workflow.

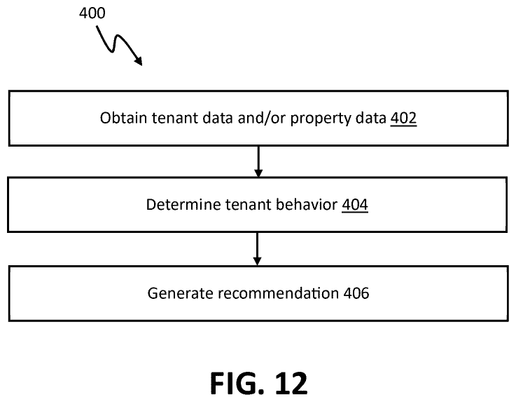

Referring to FIG. 12, a flowchart of a method 400 of generating a recommendation based on determined tenant behavior is depicted, according to an embodiment. In some embodiments, method 400 can be implemented by system 100, 200, and/or 300 as depicted in FIGS. 1-3. Reference will be made to system 100 for ease of discussion.

At 402, method 400 comprises obtaining tenant and/or property data, for example as described with respect to 302 in FIG. 11. Tenant and/or property data can be obtained as described herein.

At 404, method 400 comprises determining a tenant behavior (e.g., renter behavior). Tenant behavior can be determined by interpreting tenant data aggregated throughout the tenant lifecycle.

In embodiments, tenant behavior can be determined by property management platform 104 based on, for example, one or more of financial data, social data, tenant goals, and the like (e.g., as described herein).

In some implementations, tenant behavior can be based on rental payment history. Recognizing rental payment patterns can provide insights into tenant behavior regarding timely payments, late payments, or defaults. For example, a history of consistent on-time payments may indicate responsible behavior, while frequent late payments or defaults may signal financial challenges or reliability issues. Seasonality of payments can be incorporated into tenant behavior determinations, according to embodiments.

In some implementations, tenant behavior can be based on tracking maintenance requests and complaints. Tracking maintenance requests, repair issues, and tenant complaints can reveal tenant preferences, concerns, and priorities. Patterns in maintenance requests, such as recurring issues or frequent requests for specific services, can indicate tenant behavior and preferences regarding property maintenance.

In some implementations, tenant behavior can be based on communication and user input (e.g., via a resident interface). Processing sentiment and contents of tenant interactions, such as email correspondence, phone calls, or in-person meetings, can provide insights into communication preferences, responsiveness, and engagement levels. For example, active communication and engagement may indicate a cooperative and involved tenant, while limited communication may suggest disengagement or indifference.

In some implementations, AI engine 120 can employing machine learning techniques, such as clustering, classification, or predictive modeling, can uncover hidden patterns, trends, and correlations in tenant data. These advanced analytical methods can identify factors influencing tenant behavior and predict future behavior based on historical data.

At 406, method 400 comprises generating a recommendation, for example, based on the determined tenant behavior.

In one aspect, the report can include a recommendation (e.g., of an action to be taken) to a property manager (e.g., landlord). For example, the recommendation can be based on tenant behavior collected across a tenant set. For example, the recommendation can be to provide a cash reward to the tenant set. The magnitude, type, and or timing of the cash reward can be based on the determined tenant behavior (e.g., as described herein).

In a second aspect, property management platform 104 can provide a recommendation (e.g., of an action to be taken) to a renter. For example, the recommendation can include the renter setting a goal and/or the renter saving an amount of money. In some implementations, a reward workflow can be generated based on the recommendation. For example, an incentive, such as a discount to a vendor frequented by the renter (e.g., as determined based on a purchase history derived from financial data) can be offered if the renter follows through with the recommendation (e.g., a task based on the recommendation).

Method 400 accordingly provides for interpretation of tenant data across sources and inputs, allowing property managers to gain valuable insights into tenant behavior, preferences, and needs. These insights can inform decision-making processes, improve tenant satisfaction, and enhance overall property management practices.

In some embodiments, method 400 can be incorporated into reward workflow generation by property management platform 104 (e.g., method 300). For example, reward engine 116 can generate a reward workflow based on the recommendation and/or determined tenant behavior.

In some implementations, recommendations can be incorporated into reward workflow generation to improve efficiency over time. For example, output data evidencing the impact of reward workflows can be considered to refine development of future reward workflows and/or update tenant behavior analysis.

Embodiments of the present disclosure include systems, methods, and machine-readable programs to provide feature(s) associated with generation of reward workflows by a dynamic property management platform, for example, to improve tenant retention. In operation, the property management platform can be used to manage renters in a rental relationship with a property owner (e.g., a landlord or management company). The property management platform can be AI-enabled, in that a specially trained AI engine can be embedded in or accessible to the property management platform to facilitate meaningful iterative improvement of reward workflows and to generate recommendations to users (e.g., property owners and tenants).

In some embodiments, the property management platform provides an interface engine, for example accessible on a computing device. The interface engine can provide a resident interface through which renters can access reward workflows, versatile savings tools, and find rental units. The interface engine can provide a property management interface through which property owners can generate and customize reward workflows, find renters, and receive recommendations to improve tenant retention and cost savings. In some implementations, the interface engine can facilitate the display of and projection of prices and rates (e.g., real-estate investment values) traded on a blockchain.

In further implementations, the property management platform can induce renters to perform desired task(s), for example, through cash reward incentives. An illustrative system for doing so can include, for example, a reward engine configured to generate a reward workflow. The reward engine can select a task to be performed by a renter, associate the task with a reward, and determine a detectable condition to verify completion of the task. The reward engine can prepare and forward the reward workflow to the renter (e.g., via the interface engine) to perform the task.

If desired, the reward workflow can include instructions for performing the task. Instructions can further be provided to process task completion data received from the renter. For example, instructions can specify a condition that must be satisfied to receive a reward. Instructions can further be provided to provide a reward to the renter responsive to receipt of the task completion data. For example, instructions can specify the reward that will be received based on various conditions specified in the reward workflow. In some implementations, a reward can be provided automatically in response to receiving the task completion data (e.g., upon satisfaction of the condition). In some implementations, task completion data can include a photograph evidencing completion of the task. The photograph can include, for example, a time stamp and geocoordinates for where the photo was taken, among other things (e.g., as metadata). Instructions can further be provided to initiate payment to the renter of a reward if the geocoordinates or time stamp meet predetermined criteria associated with the task (e.g., satisfy a condition of the reward workflow). In some implementations, the task completion data can include data obtained by the renter. For example, the renter can scan a QR code at a location where a task was performed. In examples, a task can be a maintenance task, such as replacing a filter on an air conditioning unit, unclogging a drain, replacing a light bulb, and the like. In examples, a task can be a saving goal, such as saving an amount of money in an account associated with a tenant profile. The saving goal can be based on tenant-specific data, such as a percent of the tenant's rent.

In further accordance with the disclosure, the property management platform can provide a reward to a renter as a result of providing a review of the property. In an example, a magnitude of the reward can be set depending on how the property manager or landlord perceives the value of the review. For example, the magnitude of the reward (e.g., a cash reward value) can be affected by whether the review is positive or negative. While a positive review could be rewarded more than a negative review, the opposite can be practiced wherein a detailed negative review containing constructive feedback for improvement of the property can be valued comparatively highly (e.g., as this can prevent prospective or existing renters from having a negative experience in the future due to the identified deficiency).

The magnitude of the reward can be further determined based on the time (e.g., a time of year or a time of month) the task, in this example a review, was completed. For example, a higher magnitude reward (e.g., a higher value) can be set if the time of year is busy (e.g., end of year or end of month). In such an example, the increased magnitude of reward can be based on a property manager indicating an enhanced need of detailed property reviews. In still further accordance with the disclosure, the receipt of a review identifying a deficiency in a property can be configured in a manner that permits the user to identify a deficiency based on entering free form language into a data field and/or by the selection of options via radio buttons that is parsed by the property management platform to identify the deficiency. For example, the property management platform can ask the user if they would be willing to answer additional questions about the deficiency, and the magnitude of the reward can be affected by the extent to which the user submitting the review interacts with the property management platform. For example, the property management platform can be programmed, or may interface with a suitably trained AI, to ask follow-up questions to determine the nature of the deficiency, its relative urgency or severity, and identifying information. In implementations, the property management platform can determine identifying information from responses such as the location of the deficiency on the property, including whether the deficiency has occurred indoors or outdoors, what floor the deficiency has occurred in, whether the deficiency is in a generally accessible area or within a rental unit, and the like. The property management platform can refer a deficiency automatically to maintenance staff or services. If the nature of the deficiency is such that the tenant can take corrective actions to remedy the deficiency or minimize the negative effects of the deficiency, such as by putting up a warning sign, warning cones, or tape to isolate an area, the system can ask the tenant if they wish to take such actions and provide a reward workflow for doing so (e.g., such that the tenant can be rewarded accordingly for performing the preventative task). The property management platform can also ask the tenant to take photos of the deficiency before and/or after remedial action is taken to confirm that actions have been taken. Receipt of a photograph alleging that corrective action has been taken can cause the system to automatically compensate the tenant with a reward (e.g., without human intervention/approval). If it is later discovered that the tenant feigned the problem, corrective action can be taken by withdrawing the reward, or adding the magnitude of the reward into the tenant's rent bill.

In further accordance with the disclosure, the property management platform (e.g., through its various engines) is configured to measure and project the impact of reward workflows, such as reward workflows incorporating cash rewards (e.g., cash back rewards). For example, the interface engine is configured to provide a GUI that accepts inputs including, for example, tenant data and/or property data, according to embodiments. Obtained property data can include, for example, property occupancy rates; property bad debt; average unit rental amount; number of units in property; lease trade-out rates; resident retention rates; average days on market for a rental unit within the property; average days on market for a rental unit within a market; and/or average unit turnover costs. Reward engine 116 can determine a cash back offer for a given rental unit, rental event, or tenant based on obtained tenant data and/or property data. In examples, reward engine 116 can recommend the cash reward (e.g., to a user) and/or automatically implement a reward workflow incorporating the cash reward based on a condition. In examples, reward engine 116 generates a report including forecasted effects (e.g., financial projections) that a property can be expected to experience when implementing a reward workflow incorporating the cash reward.

In further accordance with the disclosure, the property management platform is configured to provide assistance to a renter in monitoring and improving their credit score. The interface engine can provide a GUI to the renter to report on-time rental payments to one or more credit bureaus to improve their credit scores. In accordance with further aspects, if desired, the user interface can include a request by the renter to have the property manager or property owner confirm that the payment has been received and applied successfully.

In some implementations, the property management platform can determine a reward associated with a reward workflow by analyzing the connection between the renter and a plurality of outcomes, or prospective rewards, in a graph database. In various embodiments, the timing, magnitude, and/or type of the reward can be selected based on the analysis of renter behaviors in order to drive a desired outcome, for example, to reduce delinquency in rental payments. If desired, the reward can be selected based on previous purchasing patterns of the renter.

Leveraging technical approaches as described herein can be used to help optimize the various problems described herein relating to property and tenant management in order to maximize owner revenue. Such technological approaches can be used to help increase or enhance homesteading, community-building, and tenant retention.

In some embodiments, a property management platform can use proprietary data it collects and AI to help property owners determine and optimize cash rewards to incentivize renter behavior for a specific rental community. Various implementations request payment from property owners to fund their cash rewards payments to their tenants who will receive the cash rewards for taking specific actions. Property owners can pay the property management platform to fund the cash rewards. Property owners can pay via different methods including through a loyalty cloud service associated with (e.g., supported by) the property management platform. Tenants can earn cash rewards from the property management platform when they take a desired behavior such as taking a tour of a residence, submitting an application for a residence, paying their rent on time, etc. The renter's action(s) can be recorded by the property management platform, for example via a cloud service, which determines the reward the renter has earned and when they should receive payment. At the appropriate time (e.g., when a condition of the reward workflow is satisfied), the property management platform can transfer the cash rewards to the tenant's cash reward account. Tenants can connect external bank accounts to the property management platform.

After the tenant connects their bank account to the property management platform, the tenant can transfer their earned cash rewards from their account in the property management platform to their external bank account. In examples, a debit card can be linked to the tenant's cash rewards, such that cash rewards can be spent without use of an external bank account.

In some implementations, tenants who are living in a property management platform enabled residence can earn cash rewards twice a month. In some implementations, the first time tenants can earn cash rewards each month is for paying their rent. In one example, if the tenant pays their rent, the tenant can earn a rent match (e.g., a portion of their rent as a cash reward). In some implementations, the second time tenants can earn cash rewards each month is for achieving a savings target (e.g., a predefined savings target based on tenant data). If the tenant hits this savings target, the tenant can earn a savings bonus cash reward. A network of partner vendors and services associated with the property management platform can offer value-add services and products to tenants, providing tenants additional opportunities to earn cash rewards through the property management platform. The property management platform can also be configured as a portal for property managers to configure reward workflows and to view reward workflow analytics.

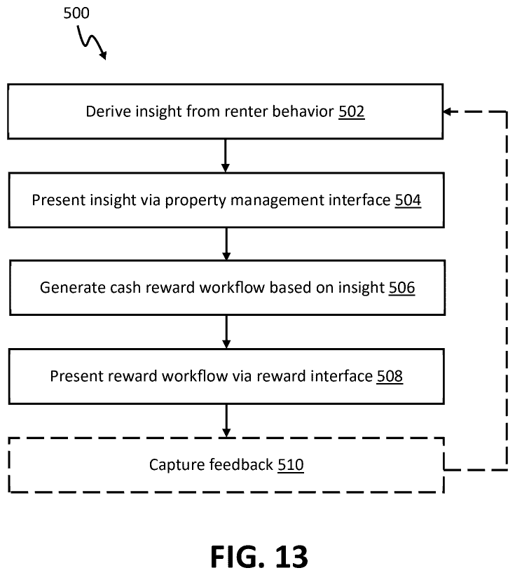

Referring to FIG. 13, a method 500 for providing a cash back reward based on renter behavior is depicted, according to an embodiment. In some embodiments, method 400 can be implemented by system 100, 200, and/or 300 as depicted in FIGS. 1-3.

At 502, method 500 comprises deriving an insight from renter behavior. In some implementations, the insight be associated with, for example, one or more of: occupancy and vacancy trends, rent payment behavior, maintenance requests, tenant demographics, communication preferences, tenant satisfaction, usage of amenities, visitor (e.g., guest) patterns, or energy usage. Insights can be based on, for example, tenant interaction with the property management platform (e.g., a frequency of use of the property management platform).

Renter behavior can include aggregated trends and/or patterns of renters associated with a particular property. In some embodiments, renter behavior can include tenant turnover rates. High turnover rates may be the basis for insights associated with issues with property management, rental prices, or property conditions. Conversely, low turnover rates can be the basis for insights associated with tenant satisfaction and stability.

Renter behavior associated with a particular tenant, set of tenants, and/or property can be compared to market trends to derive comparative insights. In some embodiments, factors influencing tenant movement (e.g., why tenants choose to move in or out) can be determined. For example, a comparison of a property that a tenant left to a competing property (e.g., the property the tenant moved to) can be used as the basis for derived insights.

In some embodiments, insights can be based on targets and/or goals. In some implementations, targets can be one or more of predefined, based on user input, or dynamically determined (e.g., by an AI engine). In some implementations, goals can include property goals. For example, an insight can be that a renewal rate is lower/higher than a target renewal. For example, an insight can be that a vacancy rate is lower/higher than a target vacancy rate. For example, an insight can be that a 30-day exposure is higher/lower than a target 30-day exposure. For example, an insight can be that a number of days on market is lower/higher than a target number of days on market.

In some embodiments, the property management platform provides tailors insights based on one or more of seasonality, demand, goals and sentiment, or strategy. These insights can inform reward workflow creations focused on improving a particular target (e.g., renewal conversions, days on market, delinquency, concession savings).

In some embodiments, the property management platform provides categorical insights based on one or more of a renter, a unit, or a property. Captured data (e.g., data points) can be labeled according to these categorizations to maintain a robust data set for a (e.g., each) renter, unit, and property. In some implementations, particular data can belong (e.g., be labeled) in multiple categories. Such categorization can be implemented on a metadata or attribute level to allow for distinct AI interpretations based on the category. For example, rent payment data can be used by a renter-specific AI algorithm to determine an indication of rent paid (e.g., a yes/no determination) while a market trend AI algorithm can require more detailed information, such as the amount of rent or provided rewards.

In some examples renter behavior can include one or more of: a review, rent payment history, contact preferences, interactions with the property management platform, effectiveness of reward workflows (e.g., reward campaigns), referrals, use of amenities. For example, renter behavior can be tracked over time to develop a robust renter profile. For example, renter feedback can be solicited (e.g., periodically) to facilitate evaluation of renter sentiment.

In some examples, renter behavior can be aggregated to generate a sentiment score. The sentiment score can be associated with a particular renter and/or set of renters (e.g., renters of a particular property). In some embodiments, the sentiment score can be qualitative or quantitative. In some implementations, administrative users (e.g., property owners, property managers) can specify what renter behaviors should be used in deriving the sentiment score and/or the weighting of such behaviors.

In some implementations, an AI engine can dynamically determine what renter behaviors are used in deriving the sentiment score and/or the weighting of such behaviors. For example, an AI engine can determine that public user reviews are a significant indicator of whether a tenant will extend a lease. The determination can be based on a comparison of historical lease extension data. For example, renters who provide a positive review of a property may sign a lease extension twice as often as renters who do not leave a review of a property. The AI engine can determine that a rating associated with a renter review should be weighted higher than other renter behavior. In some embodiments, the AI engine can automatically adjust sentiment score weighting.

In embodiments, insights can be determined based exclusively on renter behavior, such that property attributes are not considered.

At 504, method 500 comprises presenting the derived insight via a property management interface. In some embodiments, the property management interface can be configured for an administrative user (e.g., a property manager). For example, property management interface can be a property management interface incorporated into a loyalty cloud. For example, property management interface can be a property management interface incorporated into a property management application.

In some embodiments, an (e.g., each) insight can be presented with accompanying options to view insight details (e.g., the renter behavior considered when deriving the insight) and/or to generate a reward workflow (e.g., launch a campaign) associated with the insight. Streamlined presentation of derived insights can improve transparency and ease of making actionable decisions. By including optionality to review foundational data as necessary, the property management platform can build trust with users while not inundating or overwhelming users with many data points associated with renter behavior. This synthesis can be based on benchmarking current performance against historical data or market (e.g., competitor) data, identifying trends and areas for improvement over time. Further, association of actions (e.g., next steps) based on insights allows users to efficiently develop reward workflows that are tailored to a specific goal or metric, improving accountability and feedback capabilities.

In some embodiments, the property management interface can include an intuitive dashboard that provides easy-to-understand data visualizations representing key metrics and insights. For example, the dashboard can include an option to view data associated with an insight. A user selecting the option can be presented with graphs and/or charts illustrating relevant data metrics (e.g., rent payment trends or maintenance request patterns). In some implementations, the property management interface can include an indication of correlated metrics. For example, the property management interface can highlight correlations between different metrics, such as the relationship between community event participation and lease renewal rates.

In some embodiments, insights can (e.g., also) be presented to a tenant, for example via a resident interface. For example, the tenant insight can be that a saving amount is lower/higher than a target saving amount for a particular month.

At 506, method 500 comprises generating a cash reward workflow. In some embodiments, the property management interface can be configured to receive user input regarding the cash reward workflow. For example, the cash reward workflow can be based on or associated with a particular insight (e.g., derived at 502). The insight can be associated with a target metric, such as a percentage of timely rent payments, and the cash reward workflow can be directed to improving the target metric.

In some embodiments, a property management interface can present expectations and/or scenarios associated with implementing the cash reward workflow. For example, a cost associated with the workflow and/or an estimated return on investment can be presented. The property management interface can provide, for example, one or more concession comparisons, including market concessions, reward offers, and projected savings. These concession comparisons can be presented for projected savings and/or historical savings. Property attributes, including whether a property is offering a type of concession, rents associated with a property, a distance or geographical region, or a rating of a property, can be used to filter these comparisons.

In some embodiments, the cash reward workflow is cash back. The cash back reward workflow can be customized to individual tenants, units, and/or properties. In some implementations, cash back can include, for example, one or more of: on-time rent payment cash back, lease renewal incentives with cash back, maintenance cash back (e.g., if renters promptly report or resolve issues with their own funds), or purchases cash back (e.g., if renters use a card associated with the property management platform).

In some embodiments, the property management platform can provide customization options for users to tailor insights and reward programs, including cash back amounts, to their specific needs. In such an implementation, a renter who frequents a business incorporated into a property can be offered a cash back reward when frequenting the business. Accordingly, individual renters and businesses within a property can be symbiotically incentivized.

In some embodiments, the property management platform can implement cash back to renters. The property management platform can, for example, determine that tenants respond more positively to monthly credits rather than one-time incentives or concessions, such as a duration without a rent payment (e.g., a free month). Based on this determination, the property management platform can automatically generate a cash reward workflow that would offer a percentage of paid monthly rent (e.g., 3%, 5%) as cash back to the renter. This cash back reward can be restricted to on-time payments, facilitating higher rates of timely payment and tenant satisfaction for at a reduced cost (e.g., compared to other concessions such as a month of no rent). A cash reward workflow can prolong positive renter sentiment associated with receiving rewards by periodically providing an incentive rather than a one-off occurrence. Moreover, a cash reward workflow of the present disclosure can increase renter engagement with the property management platform (e.g., relative to other, conventional concessions). In some implementations, cash back rewards can be presented as currency (e.g., dollar) amounts (e.g., as opposed to percentages). For example, notifications or alerts can be provided to renters that includes an indication that the renter can earn $40 for paying rent on time or earn $10 for reaching a savings goal.

In some embodiments, the property management interface can provide users (e.g., administrative users) with the ability to update or shift cash back rewards at any point during implementation. Conventional property management approaches are often unable to provide customized rewards, such as a percentage cash back on rent, or to track overall concession budgets for such rewards.

At 508, method 500 comprises presenting the generated cash reward workflow via a reward interface. In some embodiments, the reward interface can include an action associated with earning the cash reward workflow. For example, a prompt to set up a recurring deposit can be presented via the reward interface with an indication of a cash reward amount that will be earned upon completion.

In some embodiments, the reward interface can provide updates based on progress between uses of the property management platform. For example, the reward interface can include an indication of a reward amount earned since a prior log-in associated with the user. For example, the reward interface can include display elements that update to reflect the growing earnings of the user. In some implementations, a track can include a bar that gradually fills up as the user earns more rewards (e.g., up to a monthly or yearly cap).

In some embodiments, the reward interface can include an indication of a (e.g., each) instance a cash back reward was earned and/or a quantity of the cash back.

In some embodiments, the cash reward workflow can include credit building. For example, the property management platform can automatically report on-time rent payments to help renters build credit. In some implementations, credit score increases can be presented in conjunction with cash rewards.

In some implementations, the cash reward workflow can integrate with external platforms, such as calendars, using an API. These integrations can facilitate on-time payments and indirectly prompt the renter to interact with the rewards interface.

At 510, method 500 optionally comprises capturing feedback data. The feedback data can be associated with the generated cash reward workflow (e.g., at 506) and/or renter behavior. For example, feedback data can be used to track the implementation of cash reward workflows, including which rewards were offered, accepted, and the impact of cash reward workflows on renter behaviors.

In some embodiments, feedback data captured at 510 is used to derive further insights, for example returning to 502 as illustrated.

In some embodiments, an AI engine integrated into the property management platform can continuously refine renter behavior insights based on a feedback loop from implemented cash reward workflows. This iterative process can allow the reward recommendations to remain effective and aligned with tenant behaviors and preferences. The AI engine can use machine learning algorithms (e.g., as described herein) to analyze collected data and identify trends, patterns, and correlations. For example, impact assessments (e.g., insight reports) can be provided via a property management interface that evaluate the effectiveness of cash reward workflows by measuring changes in tenant behaviors before and after the rewards were introduced. In some implementations, the AI engine can increase cost savings of administrative users by reducing the value of reward workflows during opportune times (e.g., periods of high demand).

In some embodiments, a property management interface can provide property managers with clear visualizations of feedback data and insights, along with the reasoning behind any changes or recommendations made by an AI engine.

Embodiments of the present disclosure can be used to iteratively develop insight derivation and reward workflow suggestions.

In an embodiment, on-time rent payment rewards can be implemented by the property management platform. An initial reward workflow can be to provide tenants paying rent on time a 1% cash back reward. This initial reward workflow can be suggested to an administrative user based on a likelihood of increasing a percentage of timely rent payments. After implementing the reward, rent payment and tenant satisfaction data can be captured. If the on-time payment rate increases significantly, the property management platform can provide a recommendation to maintain or slightly increase the reward. If there's minimal impact, the property management platform can dynamically reassess the reward workflow and recommend an increase of the cash back percentage or introduction of additional incentives.

In an embodiment, lease renewal incentives can be implemented by the property management platform. An initial reward workflow can be that tenants who renew their lease receive a $100 cash back bonus. A feedback loop can be implemented to monitor lease renewal rates and gather tenant feedback on the attractiveness of the incentive. The property management platform can automatically adjust the cash back amount or combine it with other rewards (e.g., cash back on rent for the duration of the new lease term) based on renewal rates and feedback data.

In an embodiment, maintenance request reporting can be implemented by the property management platform. For example, tenants reporting maintenance issues promptly can receive a $10 cash reward. The property management platform can compare an observed frequency of maintenance requests and tenant satisfaction with response time and quality of repairs to historical maintenance data. If reporting increases and satisfaction improves, the property management platform can suggest maintaining or expanding the program. If there's little change, the property management platform can suggest other incentives or methods to encourage prompt reporting.

Embodiments of the present disclosure provide for feature(s) associated with concession management. For instance, embodiments provide for systems and methods of concessions management by way of giving cash rewards to renters in response to renters taking certain actions. The timing, presentation, and value of cash rewards as well as the actions required for the renter to achieve the cash rewards can be dynamically determined based on renter behavior data, property data, and/or market data. For example, a cash back reward can be offered if a tenant renews a lease early.

In a feature and embodiment of the present disclosure, a property management platform as described herein offers multifamily and single-family property owners and operators a customizable solution to more effectively utilize renter concessions and incentives. Concessions (e.g., reward workflows) generated through the property management platform can dynamically incentivize important renter actions—signing leases, renewing leases, rent payments, and rent collections. For example, concessions can be customized for a particular renter and presented to the renter as an incentive in a resident interface. The resident interface can be, for example, a wallet (e.g., a digital wallet) and/or an application (e.g., mobile application) that the renter can use to can access financial amenities such as banking, credit building, and more offers, such as other cash back rewards.

In a feature and embodiment of the present disclosure, a property management platform as described herein captures and reports on three key types of data—renter data, property data, and market data. The property management platform can present tracked data, reports, and insights through a property management interface. In some implementations, the property management interface is accessible through the cloud (e.g., as a loyalty cloud service), for example, by property partners. The term property partner refers to a property manager, administrator, or owner that is generally responsible for finding or managing renters of a property. The property management interface is configured to display insights and optimize reward workflows (e.g., cash back concessions) to property partners based on specific renters, properties, and/or markets. This optimization allows the property management platform to provide property partners with the most efficient and effective cash back concessions for tenants. Additionally, property partners can configure their cash back concessions with the property management platform so residents can earn a cash back reward (concession) for moving into to a new community if they apply by and move-in by a given date, managed through the property management platform.

In some embodiments, the property management platform is configured to obtain and analyze renter data, property data, and/or market data. Renter data can include renter behavior data, such as signing a lease, renewing a lease, paying rent on time, referring a friend, leaving a review, providing updated contact information, spending data, average savings rate increases, and more. Property data can include, for example, days on market, concession spend by property, property delinquency rates, property renewal conversions and renewal trade-outs, property contractability rates, property spending levels, and more. Market data can include, for example, average days on market for comparable properties in the market and average concession spend for comparable properties (e.g., currently and historically). The property management platform can determine whether properties are comparable based on associated property data and/or user input from property partners.

Based in part on the aforementioned data points, the property management platform, which may be implemented as a loyalty cloud service, can generate reward workflows and incentive recommendations. These generated reward workflows can be dynamically customized based on data allowing for more cost-effective and impactful cash back offers (e.g., compared to traditional concessions). Benefits realized by these reward workflows include, reduced concession costs (e.g., saving property managers money and improving net operating income (NOI)); more signed leases (e.g., improving occupancy); higher resident retention (e.g., reducing turnover costs), and more paid rent (e.g., boosting collections). Because embodiments of the property management platform are able to more effectively price incentives based data, property managers that implement the generated reward workflows (e.g., recommended cash back offers) are able to achieve target levels of occupancy, retention, and collections while reducing concession costs (e.g., compared to conventional concessions). Cash back offers can be specifically configured for specific properties and unit types. The offers can be changed dynamically over time based on the property's performance and property and market specific data points.

As a result, embodiments of the present disclosure provide for a result-driven property management platform. The property management platform can recommend optimal rental concessions and incentives. Optimal concessions and incentives generally refer to reward workflows having rewards, such as cash back amounts, that minimize property owner investment (e.g., concession cost or price) while maximizing a desired property parameter. For example, concession recommendations can be tailored to improving occupancy, driving higher retention, and/or reducing delinquency of a rental property.

In some embodiments, the property management platform can determine an optimal price based on, for example, a target amount of improvement. For example, a property partner can specify (e.g., input) a target occupancy rate of a property and the property management platform can recommend a concession price that is optimal for the specified occupancy rate. In such examples, the property management platform can provide multiple concession prices with corresponding chances of success for each (e.g., based on renter behavior data). Accordingly, embodiments of the property management platform allow property partners to balance concession costs with desired outcomes, maximizing return on investment.

Using the property management interface (e.g., loyalty cloud interface) of the property management platform, property partners are able to set-up and manage custom cash back concession offers (e.g., reward workflows). Custom cash back concession offers can include criteria unique to a particular property, for example. Within the property management interface, property partners can use a reward engine (e.g., offer manager) to select how (e.g., reward type and value), when (e.g., active time frame(s)), and why (e.g., desired renter action) to reward renters. For example, a property partner can choose to reward a renter with a one-time bonus at move-in, a monthly cash back offer for paying rent on-time, or both.

In some embodiments, property partners can use the property management interface to implement rewards on a renter-by-renter basis. For example, a property partner can offer a first concession (e.g., a one-time bonus at move in) to a first renter and offer a second concession (e.g., monthly cash back offers for paying rent on-time) to a second renter.

In some embodiments, the property management platform can determine (e.g., recommend) properties of a reward workflow based on renter data, property data, and/or market data. Properties of the reward workflow can include, for example, time frames in which an offer is active, who qualifies for a given offer, and offer values. In some implementations, a reward workflow can include dynamic properties that update based on monitored data. For example, a cash back reward for timely paying rent can decrease in value as the rent due date approaches. In some embodiments, reward workflow properties can be automatically implemented by the property management platform, generated by a property partner using the reward engine (e.g., offer manager), or recommended by the property management platform for subsequent approval by a property partner (e.g., via a property management interface).

In some embodiments, property managers can select specific time frames in which a reward workflow (e.g., concession, offer) is active. For example, a property partner can make an offer available to every resident who applies to rent a unit of a property in a particular month (e.g., between May 1 and May 31) or only make the offer available to residents who move-in to the property by a particular date (e.g., May 15). Accordingly, the reward engine (e.g., offer manager) and property management interface empower property partners to customize reward workflows (e.g., cash back incentives) to best meet the needs of their property. The property management platform can be configured to “A/B” test different offers across different properties or the same property at different times and based on feedback adjust future offers.

Once a property partner activates a reward workflow (e.g., an offer) through the property management interface, residents who qualify for the given reward workflow receive access to a resident interface (e.g., a wallet or application). The qualified residents can (e.g., then) view, earn, and redeem reward workflows (e.g., cash back) in the resident interface based on the criteria defined in the (e.g., each) reward workflow. For example, reward workflow criteria can be previously defined by the property partner prior to activating the reward workflow. Residents who perform actions associated with a reward workflow can redeem the associated reward within the resident interface. For example, a resident can receive a move-in bonus or monthly cash back and be able to manage their funds as well as access other renter benefits of the property management platform through the resident interface.

In some embodiments, the resident interface is a digital wallet. In such embodiments, renters can earn and redeem cash back in the digital wallet. In some implementations, the digital wallet can be linked to an external banking system such that the renter can add funds to or withdraw funds from the digital wallet. For example, a renter can withdraw redeemed cash back awards or add funds to pay rent using the digital wallet.

The system (e.g., system 100, system 200) and data architecture that support the property management platform facilitate two discrete interfaces, the resident interface and the property management interface. In some embodiments, the engines and data architecture of the property management platform are critical to unifying discrete sources and types of data and connecting the interfaces to that data. While the resident interface and the property management interface are both provided by the property management platform, data and interface elements presented through each are tailored to the respective audiences. The resident interface, which may be a renter wallet, is configured for use by property tenants. The property management interface, which may be a loyalty cloud, is configured for use by property partners.

Embodiments of the present disclosure provide for a property management platform that connects different data sources to provide insights through renter and property facing interfaces. The property management platform allows for true concession management for multifamily and single-family property owners and operators. The property management platform uses data and analytics to optimize cash back offers (e.g., concessions) and present the offers and the cash back rewards to renters at times determined to maximize engagement. Accordingly, the property management platform allows for improved property performance with lower concession costs, higher occupancy, higher renewal conversions, and less delinquency.

1. A system for property management, the system comprising:
a components database configured to store a plurality of reward workflow components;
a property management platform comprising a memory and at least one processor, wherein the property management platform is configured to:
aggregate market data from at least one external data source and unify the market data into a unified dataset;
receive an indication to activate a reward workflow via a property management interface, the property management interface generated for a property manager computing device communicatively coupled over at least one network with the property management platform, wherein the reward workflow includes an action and a cash back reward, and wherein the reward workflow is based on at least one of the plurality of reward workflow components corresponding to at least one database object in the components database and the unified dataset;
activate the reward workflow based on the indication;
obtain renter behavior data for a renter user indicating the action was performed;
dynamically associate the renter user with the reward workflow in the memory, thereby providing access, according to a renter user access control, to the reward workflow to the renter user on the property management platform; and
grant, based on the reward workflow being active and the renter behavior data, the cash back reward via a resident interface, the resident interface generated for a renter computing device associated with the renter user communicatively coupled over the at least one network with the property management platform.

2. The system of claim 1, wherein:
the action is at least one of signing a lease, renewing a lease, or paying rent; and
the resident interface is configured to provide access to at least one of a bank, a credit building service, or a digital wallet.

3. The system of claim 1, wherein the property management platform is further configured to obtain tenant data, property data, and market data, and wherein the property management interface is configured to:
display at least one of the tenant data, the property data, or the market data;
generate a recommended reward workflow based on the tenant data, the property data, and the market data;
display the recommended reward workflow via the property management interface; and
receive an indication to modify the reward workflow via the property management interface.

4. The system of claim 1, wherein the indication to activate the reward workflow includes an active duration.

5. A system for managing properties, the system comprising:
a components database configured to store a plurality of reward workflow components;
a property management platform comprising a memory and at least one processor configured to implement:
an interface engine configured to:
aggregate market data from at least one external data source and unify the market data into a unified dataset,
provide a reward interface on a networked tenant computing device communicatively coupled over at least one network with the property management platform, the reward interface configured to receive tenant data and task completion data, and
receive, via the reward interface, tenant data from a tenant user operating the networked tenant computing device;
a reward engine configured to:
generate a reward workflow, wherein the reward workflow is associated with a task and a reward, and wherein the reward workflow is based on at least one of the plurality of reward workflow components corresponding to at least one database object in the components database, the unified dataset, and the tenant data, and
dynamically associate the tenant user with the reward workflow in the memory, thereby providing access, according to a tenant user access control, to the reward workflow to the tenant user on the property management platform; and
a property engine configured to:
receive, via the reward interface, task completion data associated with the reward workflow,
determine that the task is complete based on a comparison of the task completion data to the task, and
send, based on the determination that the task is complete, the reward via the resident interface.

6. The system of claim 5, wherein the task completion data includes a photograph evidencing completion of the task, a timestamp associated with a time the photograph was taken, and geocoordinates associated with a location the photograph was taken, and wherein the property engine is configured to determine that the task is complete further based on at least one of the timestamp or the geocoordinates.

7. The system of claim 5, wherein the interface engine is further configured to:
provide a property management interface to receive property data, and
receive, via the property management interface, property data indicating an attribute of a property, wherein the reward engine is configured to generate the reward workflow further based on the property data.

8. The system of claim 7, wherein the determination that the task is complete is further based on a comparison of the task completion data to the property data.

9. The system of claim 7, wherein property data is associated with a residence and the attribute of the property as least one of a rent for the residence, a cost of the residence, an occupancy rate of the residence, a delinquency rate of the residence, or an end date of a lease associated with the residence.

10. The system of claim 8, wherein the at least one processor is further configured to implement an artificial intelligence (AI) engine configured to determine a renter behavior based on the tenant data, and wherein the interface engine is configured to generate the reward workflow further based on the renter behavior.

11. The system of claim 10, wherein:
a magnitude of the reward is based on the renter behavior;
a type of the reward is based on the renter behavior; and
the reward workflow is sent, via the resident interface, at a time that is determined based on the renter behavior.

12. The system of claim 10, wherein the AI engine is further configured to generate, based on the renter behavior, a recommendation identifying an action to perform, wherein the recommendation is associated with improving tenant retention, and wherein the interface engine is further configured to provide a property management interface to send the recommendation.

13. The system of claim 12, wherein the recommendation is to provide a cash reward, wherein the reward is a cash reward, and wherein the reward engine is further configured to receive, via the property management interface, an indication that the reward workflow is approved.

14. The system of claim 10, wherein the AI engine is further configured to generate, based on the renter behavior, a recommendation identifying an action to perform, wherein the recommendation is associated with a tenant goal, and wherein the resident interface is further configured to send the recommendation.

15. The system of claim 14, wherein the tenant data includes an indication that a tenant did not pay rent on time, and wherein the action and the tenant goal are associated with timely paying rent.

16. The system of claim 5, wherein:
the tenant data includes financial data extracted from digitized financial transaction information; and
the financial data includes at least one of vendor information identifying a vendor of a purchase made by a tenant or stock keeping unit (SKU) information that identifies an item associated with the purchase.

17. The system of claim 16, wherein the at least one processor is further configured to implement an artificial intelligence (AI) engine configured to determine a purchasing pattern of a renter based on the financial data, and wherein the reward engine is configured to generate the reward workflow further based on the purchasing pattern.

18. The system of claim 8, wherein the task is at least one of at least one of referring a prospective tenant, signing a new lease, renewing a lease, providing proof of renter insurance, paying rent on time, taking a tour of a residence, submitting an application for renting a residence, or connecting a financial institution account to the property management platform.

19. A computer-implemented method executed on at least one processor, the method comprising:
storing a plurality of reward workflow components in a components database;
aggregating, at a server, market data from at least one external data source and unify the market data into a unified dataset;
providing, to a user computing device, a resident interface configured to receive tenant data and task completion data, the resident interface generated for the user computing device communicatively coupled over at least one network with the server;
receiving, at the server from the user computing device, via the resident interface, tenant data;
determining, at the server, a tenant behavior based on the tenant data;
generating, at the server, a reward workflow, wherein the reward workflow is associated with a task and a reward, wherein the reward workflow is based on at least one of the plurality of reward workflow components corresponding to at least one database object in the components database and the unified dataset;
dynamically associating the user with the reward workflow in memory, thereby providing access, according to a user access control, to the reward workflow to the user on the server;
receiving, at the user computing device, via the resident interface, task completion data associated with the reward workflow;
determining, at the server, that the task is complete based on a comparison of the task completion data to the task; and
sending, from the server to the user computing device, based on the determination that the task is complete, the reward via the resident interface.
